(19) United States
(12) Patent Application Publication
(10) Pub. No.: US 2026/0205605 A1
(43) Pub. Date: Jul. 16, 2026

(54) METHOD AND DEVICE FOR VIDEO DECODING

(71) Applicant: MONTAGE LZ TECHNOLOGIES (CHENGDU) CO., LTD., Chengdu (CN)

(72) Inventors: Youyuan HUANG, Chengdu (CN); Zhimin QIU, Chengdu (CN); Xiaomin SI, Chengdu (CN)

(21) Appl. No.: 19/428,363

(22) Filed: Dec. 22, 2025

(30) Foreign Application Priority Data
Dec. 25, 2024 (CN) 202411922940.6

(51) Int. Cl. H04N 19/167; H04N 19/129; H04N 19/13; H04N 19/176; H04N 19/423

(52) U.S. Cl. CPC H04N 19/167; H04N 19/129; H04N 19/13; H04N 19/176; H04N 19/423

(57) ABSTRACT

This application discloses a video decoding method and device. The method includes: converting a first block index of at least one decoding position of a transform block in a first scanning order into a second block index in a second scanning order, which is different from the first scanning order; and performing residual decoding on the plurality of sub-blocks of the transform block according to the first scanning order; Performing residual decoding on each sub-block includes: performing residual decoding on residual information of each decoding position in a sub-block currently decoded according to the first scanning order based on residual information, stored in a plurality of preset buffers, of one or more decoding positions that have been decoded in the transform block; and updating the residual information of the decoding positions stored in the plurality of buffers according to residual information of at least a part of decoded decoding positions.

### FIELD OF THE INVENTION

This application relates to the field of video image processing, and more particularly, to a method and device for video image decoding.

### BACKGROUND

With rapid development of the video processing technology, the amount of video data that needs to be stored or transmitted increases rapidly. In order to efficiently store and transmit video data, encoding and compression is usually performed on the video data to reduce an amount of data stored or transmitted. After the video data is obtained, decoding processing needs to be performed on the video data, so as to restore the encoded and compressed video data. In conventional technologies, a plurality of video codec standards are proposed, including H.264, H.265, High Efficiency Video Coding (HEVC), and the like. Versatile Video Coding (VVC) is a next-generation video codec standard proposed after the HVEC standard. Compared with the HEVC standard, the VVC standard can significantly improve the video compression capability.

In the VVC standard, a residual encoding technology is used to encode and decode the video data. Specifically, in the VVC standard, residual encoding and decoding are performed in a unit of a Transform Block (TB), and a maximum transform block may include 32 columns x 32 rows of residual values. The transform block may also be further divided into several sub-transform blocks, for example, a plurality of sub-transform blocks with n columns x m rows of residual values, for performing encoding and decoding respectively. Encoding and decoding may be performed on the sub-transform blocks according to a preset scanning order, and residual value encoding and decoding may be performed within each sub-transform block according to the preset scanning order.

In a process of performing residual decoding on a residual value in each decoding position in a transform block, it is usually necessary to refer to context information of the decoding position, for example, residual information of a neighboring decoding position such as a residual value or other information used to represent the residual value. To ensure integrity of the context information of each decoding position, residual information of the entire transform block usually needs to be buffered, which occupies a relatively large buffer space. In addition, for each decoding position, context information corresponding to the decoding position needs to be searched from a large amount of buffer information. For example, in the VVC video standard, assuming that a maximum transform block size is 32×32, 1024 pieces of decoded residual information need to be buffered in this case. Accordingly, for each decoding position, the corresponding context information needs to be searched each time from the buffered 1024 pieces of residual information. This also causes an excessively long time to obtain the context information required for each decoding position, which makes timing convergence difficult and reduces decoding efficiency.

Therefore, it is necessary to provide a solution capable of implementing video residual decoding with a smaller storage space and a simpler addressing mechanism.

### SUMMARY

An objective of this application is to provide a video decoding method and device, which can effectively reduce a storage space required for storing context information in a video image residual decoding process, and provide a simpler addressing mechanism, thereby further improving video decoding efficiency.

According to an aspect of this application, a video decoding method is provided for decoding a transform block of a video image, where the transform block is divided into a plurality of sub-blocks, each sub-block includes a plurality of decoding positions arranged in rows and columns, and the method includes: converting a first block index of at least one decoding position in the transform block in a first scanning order into a second block index in a second scanning order, where the second scanning order is different from the first scanning order; and performing residual decoding on the plurality of sub-blocks of the transform block according to the first scanning order; where a step of performing residual decoding on each sub-block includes: performing residual decoding on residual information of each decoding position in a sub-block currently decoded according to the first scanning order based on residual information that is of one or more decoding positions that have been decoded in the transform block and that is stored in a plurality of preset buffers; and updating the residual information of the decoding positions stored in the plurality of buffers according to residual information of at least a part of decoded decoding positions.

In an embodiment, the step of updating the residual information of the decoding positions stored in the plurality of buffers according to residual information of at least a part of decoded decoding positions includes: determining a corresponding storage location to be updated in the plurality of buffers based on at least one of a first block index and a second block index of each decoding position of the at least a part of decoding positions; and storing residual information of each decoding position of the at least a part of decoding positions into the corresponding storage location.

In an embodiment, the plurality of buffers include: a row buffer, configured to store residual information of a plurality of row reference decoding positions, where the plurality of row reference decoding positions are a plurality of decoding positions arranged in a row direction in a decoded sub-block for reference in the residual decoding of an undecoded sub-block; a column buffer, configured to store residual information of a plurality of column reference decoding positions, where the plurality of column reference decoding positions are a plurality of decoding positions arranged in a column direction in a decoded sub-block for reference by residual decoding on an undecoded sub-block; and a sub-block buffer, configured to store residual information of a decoding position that is in a current sub-block and that has been decoded; and the step of updating the residual information of the decoding positions stored in the plurality of buffers according to residual information of at least a part of decoded decoding positions includes: for each decoding position, after decoding of residual information of the decoding position is completed, determining, in a corresponding sub-block buffer based on a first block index of the decoding position, a storage location used to store the residual information of the decoding position, and storing, into the determined storage location, the residual information obtained through decoding; and for each sub-block, after decoding of all decoding positions in the sub-block is completed, respectively storing residual information of a plurality of decoding positions arranged in one or more preset rows of the sub-block into a plurality of first storage locations in the row buffer, and respectively storing residual information of decoding positions arranged in one or more preset columns of the sub-block into a plurality of second storage locations in the column buffer, where the preset rows and the preset columns are associated with a decoding mode of the transform block, each first storage location is determined based on a second block index of a corresponding decoding position in the preset rows of the sub-block, and each second storage location is determined based on a second block index of a corresponding decoding position in the preset columns of the sub-block.

In an embodiment, the step of updating the residual information of the decoding positions stored in the plurality of buffers according to residual information of at least a part of decoded decoding positions further includes: emptying the sub-block buffer before residual decoding starts on a current sub-block.

In an embodiment, the plurality of buffers further include: a diagonal buffer, configured to store residual information of a plurality of diagonal reference decoding positions, where the plurality of diagonal reference decoding positions are a plurality of decoding positions arranged in a diagonal direction in a decoded sub-block for reference by residual decoding on an undecoded sub-block; where the step of updating the residual information of the decoding positions stored in the plurality of buffers according to residual information of at least a part of decoded decoding positions further includes: after decoding of all decoding positions of the current sub-block is completed, storing residual information of a preset diagonal decoding position of the current sub-block into a third storage location in the diagonal buffer, where the preset diagonal decoding position is associated with the decoding mode of the transform block, and the third storage location is determined based on a second block index of the preset diagonal decoding position.

In an embodiment, the step of performing residual decoding on residual information of each decoding position in a sub-block currently decoded according to the first scanning order based on residual information that is of one or more decoding positions that have been decoded in the transform block and that is stored in a plurality of preset buffers includes: determining, based on a second block index of a current decoding position, a first block index and a second block index of an adjacent reference decoding position that is adjacent to the current decoding position and that is referenced by residual decoding on the current decoding position; determining a storage location of residual information of the adjacent reference decoding position in the plurality of buffers based on at least one of the first block index and the second block index of the adjacent reference decoding position, and obtaining the residual information of the adjacent reference decoding position from the determined storage location; and performing residual decoding on residual information of the current decoding position based on the obtained residual information of the adjacent reference decoding position.

In an embodiment, in a case that the decoding mode of the transform block is a conventional residual decoding mode and the first scanning order is an anti-up-right diagonal scanning order, the adjacent reference decoding position includes the following decoding positions of one or more decoding positions that have been decoded in the current sub-block, the row reference decoding position, the column reference decoding position, and the diagonal reference decoding position: a first reference decoding position adjacent to a right side of the current decoding position; a second reference decoding position adjacent to a right side of the first reference decoding position; a third reference decoding position adjacent to a lower side of the current decoding position; a fourth reference decoding position adjacent to a lower side of the third reference decoding position; and a fifth reference decoding position adjacent to a lower right corner of the current decoding position, where the one or more preset rows are two topmost rows of the current sub-block, the one or more preset columns are two leftmost columns of the current sub-block, and the preset diagonal decoding position is an top-left corner decoding position of the current sub-block.

In an embodiment, in a case that the decoding mode of the transform block is a transform skip mode and the first scanning order is an up-right diagonal scanning order, the adjacent reference decoding position includes the following decoding positions of one or more decoding positions that have been decoded in the current sub-block, the row reference decoding position, and the column reference decoding position: a sixth reference decoding position adjacent to an upper side of the current decoding position and a seventh reference decoding position adjacent to a left side of the current decoding position, where the one or more preset rows are a lowest row of the current sub-block, and the one or more preset columns are a rightmost column of the current sub-block.

In an embodiment, a quantity of storage locations in the sub-block buffer is equal to a quantity of decoding positions comprised in a maximum sub-block of the plurality of sub-blocks; a quantity of storage locations in the row buffer is equal to M×2, where M is a column size of a maximum transform block of the video image; a quantity of storage locations in the column buffer is equal to 2×N, where N is a row size of the maximum transform block of the video image; and a quantity of storage locations in the diagonal buffer is twice a quantity of sub-blocks that are in the maximum transform block of the video image and that are in a longest up-right diagonal direction.

In an embodiment, a quantity of storage locations in the sub-block buffer is equal to a quantity of decoding positions comprised in a maximum sub-block of the plurality of sub-blocks; a quantity of storage locations in the row buffer is equal to M, where M is a column size of a maximum transform block of the video image; and a quantity of storage locations in the column buffer is equal to N, where N is a row size of the maximum transform block of the video image.

In an embodiment, the residual information of each decoding position includes at least one of the following residual information: first-pass residual information, including a first flag used to indicate whether a corresponding residual value is zero, a second flag used to indicate parity of a corresponding residual absolute value, a third flag used to indicate whether the corresponding residual absolute value is greater than a first threshold, and a fourth flag used to indicate whether the corresponding residual absolute value is greater than a second threshold, where the second threshold is greater than the first threshold; second-pass residual information, including at least one of a fifth flag used to indicate a corresponding residual absolute value and a sixth flag used to indicate a corresponding residual-remainder absolute value; and third-pass residual information, including a seventh flag used to indicate whether a corresponding residual value is a positive value or a negative value, where in a case that the fourth flag indicates that the corresponding residual absolute value is greater than the second threshold, the sixth flag exists, and the residual-remainder absolute value indicates a difference absolute value between the corresponding residual absolute value and the second threshold.

In an embodiment, the step of performing residual decoding on residual information of each decoding position in a sub-block currently decoded according to the first scanning order based on residual information that is of one or more decoding positions that have been decoded in the transform block and that is stored in a plurality of preset buffers includes: performing context decoding on first-pass residual information of each decoding position in a current sub-block based on context information of the decoding position according to the first scanning order, where the context information is determined based on first-pass residual information of one or more adjacent reference decoding positions of each decoding position; performing, according to the first scanning order, first bypass decoding on second-pass residual information of each decoding position based on the first-pass residual information of the decoding position obtained through decoding and second-pass residual information of the adjacent reference decoding positions of the decoding position; and performing second bypass decoding on third-pass residual information of each decoding position according to the first scanning order.

In an embodiment, the step of performing second bypass decoding on third-pass residual information of each decoding position includes: performing second bypass decoding on third-pass residual information of a non-zero decoding position in the current sub-block, where the non-zero decoding position is a decoding position whose corresponding residual value is not zero as indicated by a first flag in the current sub-block.

In an embodiment, the step of performing context decoding on first-pass residual information of each decoding position in a current sub-block based on context information of the decoding position includes: determining a context index value of a current decoding position based on first-pass residual information of one or more adjacent reference decoding positions of the current decoding position; determining the context information based on the determined context index value; and performing context decoding on first-pass residual information of the current decoding position based on the context information.

In an embodiment, the step of performing first bypass decoding on second-pass residual information of each decoding position based on the first-pass residual information of the decoding position obtained through decoding and second-pass residual information of the adjacent reference decoding positions of the decoding position includes: determining, based on the first-pass residual information of each decoding position obtained through decoding, a quantity of decoding positions to be decoded by the first bypass decoding, and determining one or more first decoding positions corresponding to the determined quantity; and performing first bypass decoding on second-pass residual information of the first decoding position based on second-pass residual information of one or more adjacent reference decoding positions of the first decoding position.

In an embodiment, the step of performing first bypass decoding on second-pass residual information of the first decoding position based on second-pass residual information of one or more adjacent reference decoding positions of the first decoding position includes: determining a k value cRiceParam of the first decoding position based on the second-pass residual information of the adjacent reference decoding positions of the first decoding position; performing Context-Adaptive Binary Arithmetic Coding (CABAC) decoding on a prefix code word and a suffix code word of the first decoding position; determining a Limited-EGk code of second-pass residual information of the first decoding position based on the k value cRiceParam of the first decoding position, the prefix code word and the suffix code word obtained through decoding; and decoding the Limited-EGk code to determine the second-pass residual information of the first decoding position.

In an embodiment, the context decoding is CABAC decoding, and the first bypass decoding and the second bypass decoding are equiprobable CABAC decoding.

According to another aspect of this application, a video decoding device is provided for decoding a transform block of a video image, where the transform block is divided into a plurality of sub-blocks, and each sub-block includes a plurality of decoding positions arranged in rows and columns. The device includes: index conversion means, configured to convert a first block index of at least one decoding position of the transform block in a first scanning order into a second block index in a second scanning order, where the second scanning order is different from the first scanning order; decoding means, configured to perform residual decoding on the plurality of sub-blocks of the transform block according to the first scanning order; and a plurality of buffers, configured to store residual information of one or more decoding positions that have been decoded, where the decoding means includes: a residual decoding unit, configured to perform residual decoding on residual information of each decoding position in a sub-block currently decoded according to the first scanning order based on residual information that is of one or more decoding positions that have been decoded in the transform block and that is stored in a plurality of preset buffers; and a residual information updating unit, configured to update the residual information of the decoding positions stored in the plurality of buffers according to residual information of at least a part of decoded decoding positions.

In an embodiment, the residual information of each decoding position includes at least one of the following residual information: first-pass residual information, including a first flag used to indicate whether a corresponding residual value is zero, a second flag used to indicate parity of a corresponding residual absolute value, a third flag used to indicate whether the corresponding residual absolute value is greater than a first threshold, and a fourth flag used to indicate whether the corresponding residual absolute value is greater than a second threshold, where the second threshold is greater than the first threshold; second-pass residual information, including at least one of a fifth flag used to indicate a corresponding residual absolute value and a sixth flag used to indicate a corresponding residual-remainder absolute value; and third-pass residual information, including a seventh flag used to indicate whether a corresponding residual value is a positive value or a negative value, where in a case that the fourth flag indicates that the corresponding residual absolute value is greater than the second threshold, the sixth flag exists, and the residual-remainder absolute value indicates a difference absolute value between the corresponding residual absolute value and the second threshold.

In an embodiment, the residual decoding unit is configured to: perform context decoding on first-pass residual information of each decoding position in a current sub-block based on context information of the decoding position according to the first scanning order, where the context information is determined based on first-pass residual information of one or more adjacent reference decoding positions of each decoding position; perform, according to the first scanning order, first bypass decoding on second-pass residual information of each decoding position based on the first-pass residual information of the decoding position obtained through decoding and second-pass residual information of the adjacent reference decoding positions of the decoding position; and perform second bypass decoding on third-pass residual information of each decoding position according to the first scanning order.

In an embodiment, the residual decoding unit includes: a context information storage module, a Limited-EGk decoding module, a CABAC decoding module, and a residual decoding module, where the operation of performing context decoding on the first-pass residual information of each decoding position includes: determining a context index of first-pass residual information of each decoding position by using the residual decoding module based on one or more adjacent reference decoding positions of the decoding position; determining, based on the context index, context information for each decoding position by using the context information storage module; in response to a request sent by the residual decoding module for decoding the first-pass residual information of each decoding position, performing CABAC decoding on the first-pass residual information of the decoding position by using the CABAC decoding module by using the context information of the decoding position, to obtain a first-pass binary bit string of the first-pass residual information of the decoding position; and decoding the first-pass binary bit string by using the residual decoding module, to obtain the first-pass residual information of each decoding position; where the operation of performing first bypass decoding on second-pass residual information of each decoding position based on the first-pass residual information of the decoding position obtained through decoding and second-pass residual information of the adjacent reference decoding positions of the decoding position includes: determining, by using the residual decoding module based on the first-pass residual information of each decoding position obtained through decoding, a quantity of first decoding positions at which Limited-EGk decoding needs to be performed, and determining, by using the residual decoding module, a k value cRiceParam of each first decoding position based on the second-pass residual information of the adjacent reference decoding positions of the first decoding position; sending, by using the residual decoding module, the quantity and the k value cRiceParam to the Limited-EGk decoding module; in response to a request sent by the Limited-EGk decoding module for decoding prefix code words and suffix code words of the number of first decoding positions, performing CABAC decoding on a prefix code word and a suffix code word of each first decoding position by using the CABAC decoding module, to obtain a second-pass binary bit string of a pair of prefix code word and suffix code word of each first decoding position; converting the second-pass binary bit string of each first decoding position into a corresponding prefix code word and suffix code word by using the Limited-EGk decoding module based on the k value cRiceParam, and obtaining a corresponding Limited-EGk code of each first decoding position by combining the prefix code word and the suffix code word that are obtained through conversion; and decoding the Limited-EGk code by using the residual decoding module, to obtain the second-pass residual information of each first decoding position, where the step of performing second bypass decoding on the third-pass residual information of each decoding position includes: in response to a request sent by the residual decoding module for decoding the third-pass residual information of each decoding position, performing CABAC decoding on the third-pass residual information of each decoding position by using the CABAC decoding module, to obtain a third-pass binary bit string of third-pass residual information of all decoding positions of the current sub-block; and decoding the third-pass binary bit string by using the residual decoding module, to obtain the third-pass residual information of each decoding position.

The foregoing is an overview of this application, and there may be cases of simplification, generalization, and omission of details. Therefore, a person skilled in the art should recognize that this part is merely illustrative and is not intended to limit the scope of this application in any way. This summary is not intended to determine the key or necessary features of the claimed protection subject matter, nor is it intended to be used as an auxiliary means of determining the scope of the claimed protection subject matter.

### BRIEF DESCRIPTION OF DRAWINGS

The foregoing and other features of the content of this application will be more fully understood by a person skilled in the art through the following detailed description with reference to the accompanying drawings and accompanying claims. It may be understood that these accompanying drawings and detailed descriptions describe only some example implementations of the content of this application, and should not be considered as limiting the content scope of this application. By referring to the accompanying drawings, the content of this application will be more clearly and in detail described.

FIG. 1 shows a flowchart of a video residual decoding method according to an example embodiment of the present invention.

FIG. 2A shows an index of each decoding position in a transform block in a raster scanning order according to an example embodiment of the present invention.

FIG. 2B shows a schematic diagram of performing residual decoding on a transform block and a plurality of transform sub-blocks obtained by dividing the transform block according to an example embodiment of the present invention.

FIG. 3 shows a method for performing residual decoding on a sub-block in a transform block according to an example embodiment of the present invention.

FIG. 4 shows a schematic diagram of a storage space of each buffer according to an example embodiment of the present invention when a maximum transform block size is 32×32 and a sub-block size is 4×4.

FIG. 5A to FIG. 5D show schematic diagrams of updating residual information stored in various buffers according to an example embodiment of the present invention.

FIG. 6 shows a decoding order in an up-right diagonal scanning order in a skip mode and a first block index of each decoding position according to an example embodiment of the present invention.

FIG. 7 shows a decoding order in a raster scanning order in a skip mode and a second block index of each decoding position.

FIG. 8 shows a schematic diagram of a storage space for each buffer in a skip mode according to an example embodiment of the present invention when a maximum transform block size is 32×32.

FIG. 9 shows a sequence and processing of decoding residual information according to an example embodiment of the present invention.

FIG. 10 shows a schematic diagram of a residual decoding means according to the present invention.

FIG. 11 shows an example flowchart of performing residual decoding on a current sub-block according to an example embodiment of the present invention.

FIG. 12 shows a schematic diagram of state transition of a Limited-EGk state machine of a Limited-EGk decoding module according to an example embodiment of the present invention.

FIG. 13 shows a schematic diagram of state transition of a CABAC state machine of a CABAC decoding module according to an example embodiment of the present invention.

FIG. 14A shows a residual value and a decoding order at each decoding position in a to-be-decoded sub-block.

FIG. 14B shows a decoding timing diagram of residual values of 16 decoding positions in the sub-block shown in FIG. 14A in an anti-up-right diagonal scanning order.

FIG. 14C shows values of related parameters during decoding at the 16 decoding positions in the sub-block shown in FIG. 14A in the sequence shown in FIG. 14A.

FIG. 15 shows a block diagram of a video decoding device according to an example embodiment of the present invention.

### DESCRIPTION OF EMBODIMENTS

In the following detailed description, references are made to the accompanying drawings that form a part of the specification. In the accompanying drawings, similar symbols generally represent similar components unless the context otherwise states. The detailed description, the accompanying drawings, and the illustrative embodiments described in the claims are not intended to be limiting. Other implementations may be used and other changes may be made without departing from the spirit or scope of the subject matter of this application. It may be understood that the various aspects of the content of this application, which are generically described herein and illustrated in the accompanying drawings, may be configured, substituted, combined, and designed in a variety of different compositions, all of which are expressly intended to form part of the content of this application.

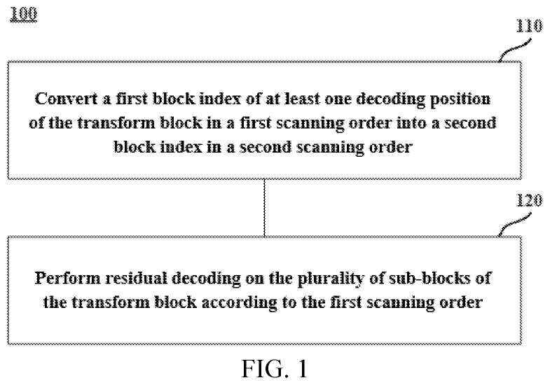

FIG. 1 shows a flowchart of a video residual decoding method 100 according to an example embodiment of the present invention. The method 100 may be used to decode a transform block of a video image.

Referring to FIG. 1, in step 110, a first block index of at least one decoding position of a current to-be-decoded transform block in a first scanning order may be converted into a second block index in a second scanning order, where the second scanning order is different from the first scanning order.

In an example embodiment of the present invention, the transform block may be divided into a plurality of sub-blocks, and each sub-block may include a plurality of decoding positions arranged in rows and columns. According to the first scanning order, each sub-block may be decoded sequentially between these sub-blocks, and each decoding position may also be decoded inside each sub-block. The first block index refers to an index allocated according to the first scanning order. For example, in a case in which a size of the transform block is 16×16, a size of the sub-block is 4×4, and the first scanning order is an anti-up-right diagonal scanning order, first block indexes 255, 254, . . . , 1, and 0 are allocated to decoding positions in the transform block, that is, decoding is performed in a sequence from 255 to 0. However, the first scanning order is not limited to the anti-up-right diagonal scanning order, but may be another scanning order. In this case, different first block indexes corresponding to each of the decoding positions may be determined.

In addition, in this embodiment of the present invention, the second scanning order may be another scanning order different from the first scanning order, for example, a raster scanning order. The second block index is an index allocated according to the second scanning order.

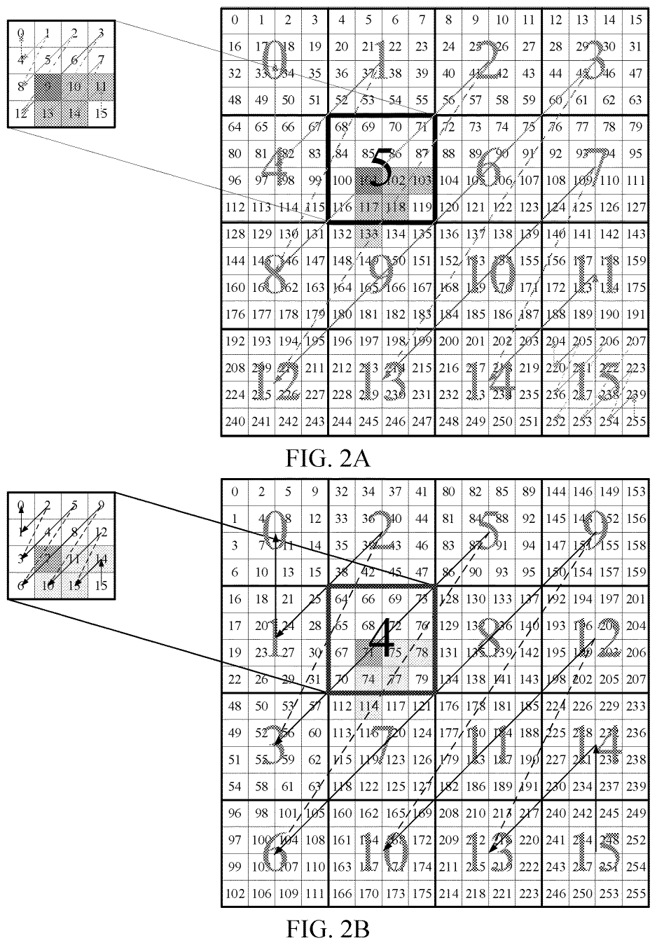

FIG. 2A shows an index of each decoding position in a transform block in a raster scanning order according to an example embodiment of the present invention. In a raster scanning process, scanning light starts from an upper left corner of an image and scans each row from left to right in a horizontal direction, and an index of the scanning order of the scanning light is shown in FIG. 2A. The transform block is divided into 16 sub-blocks, and the sub-blocks are decoded in an anti-up-right diagonal scanning order (a sequence indicated by a dashed line with an arrow in the transform block in FIG. 2A). Each decoding position inside each sub-block may be decoded in the anti-up-right diagonal scanning order (the sequence indicated by the dashed line with an arrow in the sub-block in FIG. 2A). After the decoding orders between the sub-blocks and the decoding positions inside each sub-block are determined, an entire decoding order between 256 decoding positions in the transform block may be determined, and second block indexes 255, 254, . . . , 1, and 0 in the transform block may be allocated to the 256 decoding positions in accordance with the entire decoding order, as shown in FIG. 2A.

FIG. 2B shows a schematic diagram of performing residual decoding on a transform block and a plurality of transform sub-blocks obtained by dividing the transform block. As shown in FIG. 2B, the transform block may be divided into 16 sub-blocks, and the 16 sub-blocks may be decoded, for example, in an anti-up-right diagonal scanning order. For example, decoding may be performed in a decoding order shown by an arrow direction of a dashed line with an arrow inside the transform block in FIG. 2B. For ease of description, as shown in FIG. 2B, indexes 15, 14, . . . , 1, and 0 may be sequentially allocated to the 16 sub-blocks obtained by dividing the transform block in the decoding order.

In addition, 16 decoding positions inside each sub-block may also be decoded, for example, in the anti-up-right diagonal scanning order, such as a decoding order shown by an arrow direction of a dashed line with an arrow inside a sub-block 4 in FIG. 2B. For ease of description, indexes 15, 14, . . . , 1, and 0 in the sub-block 4 may be sequentially allocated to 16 decoding positions in the sub-block 4 in the decoding order.

With reference to FIG. 2A, the foregoing explains a first block index and a second block index that are corresponding to each decoding position in the same transform block in an anti-up-right diagonal scanning order and a raster scanning order. In an example embodiment of the present invention, a mapping relationship between a first block index and a second block index of each decoding position may be pre-stored, so that when residual decoding is performed, a first block index of each decoding position in a transform block in an anti-up-right diagonal scanning order (corresponding to the first scanning order) is converted into a second block index thereof in a raster scanning order (corresponding to the second scanning order), or vice versa in a manner of table lookup, according to the pre-stored mapping relationship.

In an example embodiment of the present invention, step 110 may be performed before the transform block is decoded, so as to obtain the second block index of each decoding position in the transform block; or step 110 may be performed before each sub-block is decoded, so as to obtain a second block index of each decoding position in a currently decoded sub-block; or step 110 may be performed before each decoding position is decoded, so as to obtain a second block index of a current decoding position. That is, although step 110 is performed before step 120 as shown in FIG. 1, this is merely an example. This application is not limited thereto. Step 110 may be performed in parallel, alternately, or simultaneously with step 120. The present invention sets no limitation on an execution timing or sequence of step 110, provided that the solution of the present invention can be implemented.

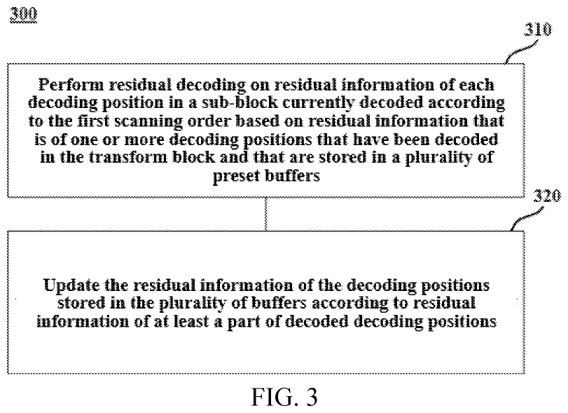

After the second block index of the decoding position in the transform block in the second scanning order is determined, in step 120, residual decoding may be performed on the plurality of sub-blocks of the transform block according to the first scanning order. The following describes in detail a decoding process of step 120 in FIG. 1 with reference to FIG. 3 to FIG. 14.

In the following detailed description, for ease of understanding, a residual decoding process is mainly described in detail by using an example in which a first scanning order is an anti-up-right diagonal scanning order, a second scanning order is a raster scanning order, a size of a transform block is 16×16, and a size of a sub-block is 4×4. However, a person skilled in the art may understand that the decoding process is an example, and the decoding process may be adjusted according to a size of a transform block or a sub-block and a specific scanning order.

FIG. 3 shows a method 300 for performing residual decoding on a sub-block in a transform block according to an example embodiment of the present invention.

As shown in FIG. 3, in step 310, residual decoding may be performed on residual information of each decoding position in a currently decoded sub-block according to the first scanning order based on residual information that is of one or more decoding positions that have been decoded in the transform block and that is stored in a plurality of preset buffers.

In step 310, before decoding for any decoding position, an adjacent reference decoding position corresponding to the decoding position may be first determined. The determining of the adjacent reference decoding position is associated with a decoding mode used by the transform block and the first scanning order used. For example, in a case in which the decoding mode of the transform block is a conventional mode and the first scanning order used is an anti-up-right diagonal scanning order, one or more adjacent reference decoding positions of each decoding position may include a first reference decoding position adjacent to a right side of the decoding position, a second reference decoding position adjacent to a right side of the first reference decoding position, a third reference decoding position adjacent to a lower side of the decoding position, a fourth reference decoding position adjacent to a lower side of the third reference decoding position, and a fifth reference decoding position adjacent to a lower right corner of the decoding position. For another example, in a case in which the decoding mode of the transform block is a skip mode and the first scanning order used is an anti-up-right diagonal scanning order, one or more adjacent reference decoding positions of each decoding position may include a sixth reference decoding position adjacent to an upper side of the decoding position and a seventh reference decoding position adjacent to a left side of the decoding position.

In an example embodiment of the present invention, a first block index and a second block index of one or more adjacent reference decoding positions of each decoding position may be determined based on a second block index of the decoding position, and a storage location of residual information of the adjacent reference decoding position in a preset plurality of buffers may be determined based on at least one of the first block index and the second block index of the adjacent reference decoding position, thereby obtaining residual information of the adjacent reference decoding position from the determined storage location. Then, residual decoding may be performed on the residual information of the current decoding position based on the obtained residual information of the adjacent reference decoding position. This decoding process will be explained in more detail below.

In an example embodiment of the present invention, the foregoing plurality of preset buffers may respectively store residual information of one or more adjacent reference decoding positions corresponding to each decoding position. In addition, because adjacent reference decoding positions corresponding to each decoding position in different decoding modes and/or scanning modes may be different, a plurality of buffers may be respectively set for different decoding modes (for example, a conventional mode or a skip mode) and/or scanning modes, or different decoding modes and/or scanning modes may share same plurality of buffers.

In the conventional mode, the preset plurality of buffers may include a sub-block buffer, a row buffer, a column buffer, and a diagonal buffer. The sub-block buffer may be configured to store residual information of a decoding position that is in a corresponding sub-block and that has been decoded. For example, when residual decoding is performed on a sub-block, corresponding residual information obtained through decoding a sub-block may be stored in the sub-block buffer after residual decoding at a decoding position is completed each time. The row buffer may be configured to store residual information of a plurality of row reference decoding positions, and the column buffer may be configured to store residual information of a plurality of column reference decoding positions. Herein, the plurality of row reference decoding positions may be a plurality of decoding positions arranged in a row direction in a decoded sub-block, and the plurality of column reference decoding positions may be a plurality of decoding positions arranged in a column direction in a decoded sub-block. In addition, the diagonal buffer may be configured to store residual information of a plurality of diagonal reference decoding positions, and the plurality of diagonal reference decoding positions may be a plurality of decoding positions arranged in a diagonal direction in a decoded sub-block. In this case, when residual decoding is performed on any decoding position, the adjacent reference decoding positions referred to may include the foregoing first to fifth reference decoding positions adjacent to the decoding position, which are selected from the decoded decoding positions in the sub-block to which the decoding position belongs, the row reference decoding positions, the column reference decoding positions and the diagonal reference decoding positions.

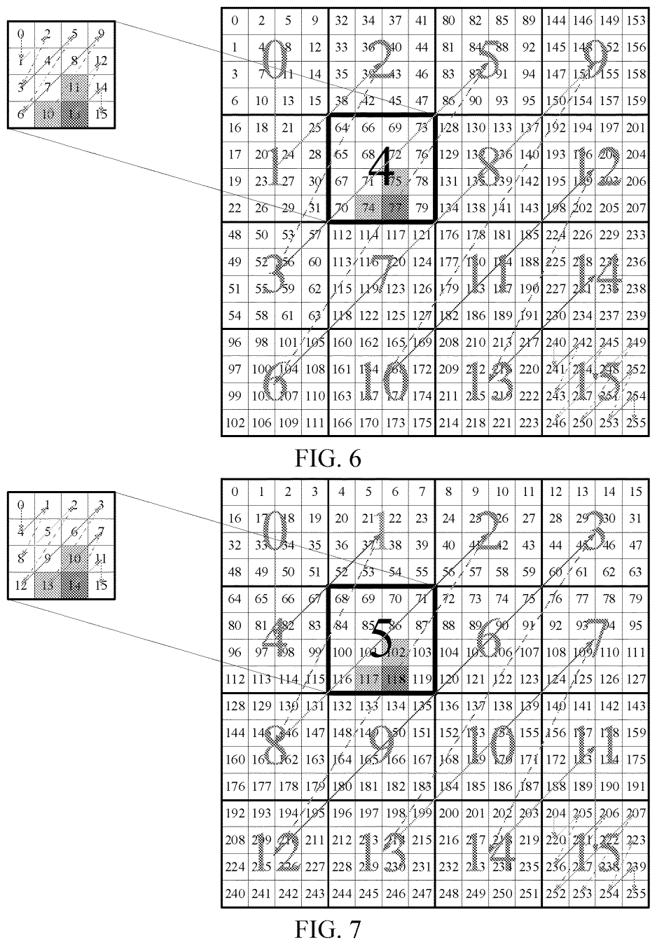

According to another example embodiment of this application, in the skip mode, a plurality of buffers may include only the foregoing sub-block buffer, row buffer, and column buffer. In this case, when residual decoding is performed on any decoding position, the adjacent reference decoding positions referred to may include the foregoing sixth and seventh reference decoding positions adjacent to the decoding position, which are selected from the decoded decoding positions in the sub-block to which the decoding position belongs, the row reference decoding positions and the column reference decoding positions. This case will be explained in detail later with reference to FIG. 6 to FIG. 8.

For ease of understanding, only as an example, a residual decoding operation is described below by performing residual decoding on a decoding position D[71] whose first block index is 71 in a sub-block 4 shown in FIG. 2B in the conventional mode. In the following, for simplicity, the decoding position D[71] may also be referred to as a “current decoding position”.

As shown in FIG. 2B, in the conventional mode, an adjacent reference decoding position referred to when performing residual decoding on the current decoding position may include a first reference decoding position adjacent to a right side of the current decoding position, that is, a decoding position D[75]; a second reference decoding position adjacent to a right side of the first reference decoding position, that is, a decoding position D[78]; a third reference decoding position adjacent to a lower side of the current decoding position, that is, a decoding position D[74]; a fourth reference decoding position adjacent to a lower side of the third reference decoding position, that is, a decoding position D[114]; and a fifth reference decoding position adjacent to a lower right corner of the current decoding position, that is, a decoding position D[77].

In this embodiment of the present invention, after a second block index 101 of the current decoding position D[71] is determined, for example, by using the table lookup manner described above, the second block indexes of the adjacent reference decoding positions D[75], D[78], D[77], D[74], and D[114] of the current decoding position may be determined as follows: D[75]=R[102]=R[101+1]; D[78]=R[103]=R[101+2]; D[77]=R[118]=R[101+W+1]; D[74]=R[117]=R[101+W]; D[114]=R[133]=R[101+W×2]. R[X] indicates a decoding position with a second block index X according to a second scanning order, and W may indicate a width size of the transform block. For example, W in FIG. 2B is 16.

After the second block indexes of the adjacent reference decoding positions are determined in the foregoing manner, the first block indexes of the adjacent reference decoding positions may be determined with reference to the conversion manner between the indexes described above.

After the adjacent reference decoding positions of the current decoding position are determined, residual information of the adjacent reference decoding positions may be obtained from the buffer. To determine the residual information of the adjacent reference decoding positions of the current decoding position, first, storage locations of the residual information of the adjacent reference decoding positions in their corresponding buffers needs to be determined. The following describes in detail a method for determining storage locations of residual information of adjacent reference decoding positions in each corresponding buffer.

In an example embodiment of the present invention, a quantity of storage locations in a sub-block buffer may be equal to a quantity of decoding positions included in a maximum sub-block of a plurality of sub-blocks, a quantity of storage locations in a row buffer may be equal to M×2, M may be a column size of a maximum transform block of a video image, a quantity of storage locations in a column buffer may be equal to 2×N, N may be a row size of a maximum transform block of a video image, and a quantity of storage locations in a diagonal buffer may be twice a quantity of sub-blocks located along the longest up-right diagonal direction in the maximum transform block of the video image. For example only, the 16×16 transform block and the 4×4 sub-block shown in FIG. 2B are still used as examples for explanation. In this case, also as an example, a storage size of a used sub-block buffer may be 4×4, a size of a row buffer may be 16×2, a size of a column buffer may be 2×16, and a size of a diagonal buffer may be 2×4.

In an example embodiment of the present invention, when the current decoding position is located in the same sub-block as its adjacent reference decoding position, residual information of the adjacent reference decoding position is stored in a corresponding sub-block buffer. Therefore, a storage location of the residual information of the adjacent reference decoding position in the corresponding sub-block buffer needs to be determined, and the residual information of the adjacent reference decoding position needs to be obtained from the storage location. Herein, a storage location C[cn] of the adjacent reference decoding position in the corresponding sub-block buffer may be determined based on a first block index of the adjacent reference decoding position, where cn=f_diagScan2rasterScan(resIdx[3:0]), which indicates an index of the storage location C[cn], resIdx is the first block index of the reference decoding position, resIdx[3:0] indicates taking the 4 lower bits of the binary value of resIdx, f_diagScan2rasterScan(resIdx[3:0]) indicates a value obtained through table lookup by using resIdx[3:0] as an index, and the table is a preset mapping relationship table between resIdx[3:0] and a storage location index cn of a corresponding sub-block buffer. For example, if a binary form of a first block index 78 of the adjacent reference decoding position D[78] is 1001110, the corresponding resIdx[3:0] is a binary value “1110” and a corresponding decimal value is “14”. Through table lookup, it may be determined that residual information of the adjacent reference decoding position whose first block index is “78” is stored in a storage location whose index is 11 in the corresponding sub-block buffer.

In addition, when the current decoding position is located in a different sub-block from its adjacent reference decoding position, residual information of the adjacent reference decoding position is not stored in a corresponding sub-block buffer, but may be stored in at least one of a row buffer, a column buffer, and a diagonal buffer. Therefore, the storage locations of the residual information of the adjacent reference decoding positions in these buffers need to be determined, and the residual information of the adjacent reference decoding positions need to be obtained from the storage locations. Herein, the storage locations of the residual information of the adjacent reference decoding positions in the foregoing buffers may be determined based on a second block index of the adjacent reference decoding position and the following formula:

$$TBx = rasterIdx \& ( TBw - 1 ) ;$$

$$TBy = rasterIdx / TBw ;$$

$$B [ xb ] [ yb ] , xb = TBx \& 31 , yb = TBy \& 1 ;$$

$$A [ xa ] [ ya ] , xa = TBx \& 1 , ya = TBy \& 31 ;$$

$$M [ xm ] [ ym ] , xm = ( TBx ≫ 2 ) \& 1 , ym = ( TBy ≫ 2 ) \& 7 ;$$

where TBw represents the width size of the transform block. For example, when the size of the transform block is 32×32, TBw is 32, and when the size of the transform block is 16×16, TBw is 16. TBx and TBy represent x-axis coordinates and y-axis coordinates of a decoding position when an upper left vertex of the transform block is taken as the coordinate origin, a height direction is the y-axis direction, and a width direction is the x-axis direction. For example, coordinates of a decoding position whose first block index is “75” may be [6, 6], and coordinates of a decoding position whose first block index is “71” may be [5, 6].

rasterIdx is the second block index of the decoding position, “&” indicates a bitwise AND operation, “/” indicates an integer division operation, and “>>” indicates a right shift operation. B[xb][yb] represents a storage location in the row buffer, A[xa][ya] represents a storage location in the column buffer, and M[xm][ym] represents a storage location in the diagonal buffer.

In an example embodiment of the present invention, a buffer in which residual information of an adjacent reference decoding position is stored may be determined according to a positional relationship between the adjacent reference decoding position and the current decoding position. Merely by way of example, a decoding position whose second block index is “133” is a row reference decoding position of the current decoding position, so the residual information of the row reference decoding position may be obtained from the row buffer, and a storage location of the row reference decoding position may be determined as B[5][0] based on the calculation manner described above.

In some embodiments, it may be determined whether the current decoding position and its adjacent reference decoding position are in the same sub-block as or a different sub-block from a current sub-block according to the index of the reference decoding position in the sub-block buffer. For example, if a binary form of a first block index 71 of the adjacent reference decoding position D[71] is 1000111, the corresponding resIdx[3:0] is a binary value “0111” and a corresponding decimal value is “7”. Through table lookup f_diagScan2rasterScan(resIdx[3:0]), it may be determined that residual information of the adjacent reference decoding position whose first block index is “71” is stored in a storage location whose index cn is 9 in a sub-block buffer. Specifically, when row and column coordinates of the current decoding position in the current sub-block are (2, 1), coordinates of the first reference decoding position adjacent to the right side of the current decoding position in the current sub-block are (2, 2). In this case, for the first reference decoding position of the coordinates (2, 2), it may be further determined whether two lower bit values of the index cn are less than 3. In addition, coordinates of the second reference decoding position are (2, 3). In this case, for the second reference decoding position of the coordinates (2, 3), it may be further determined whether two lower bit values of the index cn are less than 2. Similarly, for other reference decoding positions, the value of index cn may also be used to determine whether the other reference decoding positions are in the current sub-block.

Based on the foregoing manner, residual information respectively corresponding to adjacent reference decoding positions R[102], R[103], R[118], and R[119] may be obtained from storage locations C[10], C[11], C[14], and C[13] in the sub-block buffer, and residual information of an adjacent reference decoding position R[133] may be obtained from the storage location B[5][0] in the row buffer. In this manner, storage locations of residual information of each adjacent reference decoding position may be obtained through simple calculation based on position information of the current decoding position in the transform block. Because the storage locations of residual information of each decoding position may be determined in the foregoing manner, addressing difficulty is greatly reduced.

It should be understood that the foregoing buffers are merely examples, and this application is not limited thereto. For example, a storage size of a sub-block buffer may be 1×16 or 16×1.

In addition, a quantity of storage locations of the sub-block buffer may depend on a size of a sub-block of the transform block, and a quantity of storage locations of other buffers may depend on a size of a maximum transform block of all video images of a video stream. For example, when the size of the maximum transform block is 32×32 and the size of the sub-block is 4×4, the quantity of storage locations of the sub-block buffer may be 4×4, the quantity of storage locations of the row buffer may be 32×2, the quantity of storage locations of the column buffer may be 2×32, and the quantity of storage locations of the diagonal buffer may be 2×8.

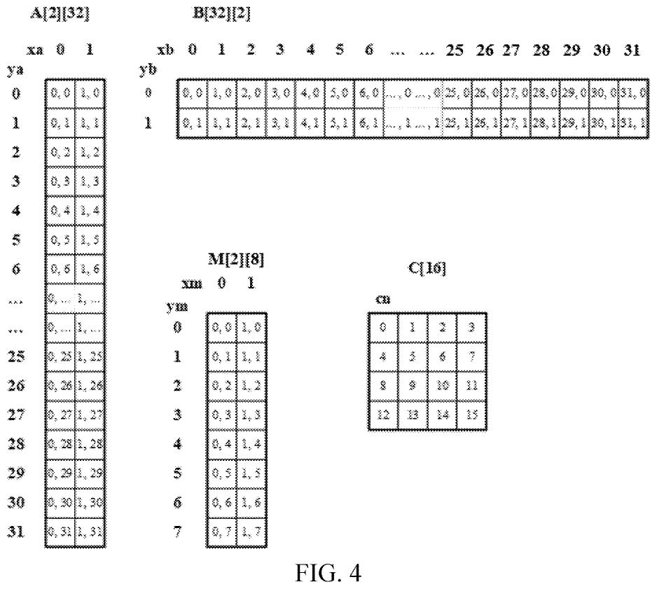

FIG. 4 shows a schematic diagram of a storage space of each buffer according to an example embodiment of the present invention when a maximum transform block size is 32×32 and a sub-block size is 4×4.

Referring to FIG. 4, A represents a column buffer, and xa∈[0, 1] and ya∈[0, 1, . . . 30, 31] respectively represent a storage location column index and row index in the column buffer. B indicates a row buffer, and xb∈[0, 1, . . . , 30, 31] and yb∈[0, 1] respectively represent a storage location column index and row index in the row buffer. M represents a diagonal buffer, and xm∈[0, 1] and ym∈[0, 1, 2, . . . , 7] respectively represent a storage location column index and row index in the diagonal buffer. C represents a sub-block buffer, and cn∈[0, 1, . . . 15, 16] represents an index of a storage location in the sub-block buffer.

As shown in FIG. 4, a storage space of all buffers includes a total of 160 storage locations. That is, in a case in which the size of the maximum transform block is 32×32, only a maximum of 160 storage locations are required to buffer residual information, which further reduces a storage space size compared with the prior art.

After the residual information of each adjacent reference decoding position is obtained by using the foregoing method, residual decoding may be performed on the current decoding position based on the obtained residual information of the adjacent reference decoding positions to determine the residual information of the current decoding position. The decoding process will be described in detail later.

Referring back to FIG. 3, in step 320, the residual information of the decoding positions stored in the plurality of buffers is updated according to residual information of at least a part of decoded decoding positions.

In an example embodiment of the present invention, corresponding storage locations to be updated in the plurality of buffers may be determined based on at least one of a first block index and a second block index of each of the at least a part of decoded decoding positions, and residual information of each of the at least a part of decoded decoding positions is stored in a corresponding storage location.

Specifically, for each decoding position, after decoding of residual information of the decoding position is completed, a storage location used to store the residual information of the decoding position may be determined in a corresponding sub-block buffer based on a first block index of the decoding position, and the residual information obtained through decoding is stored into the determined storage location. A manner of determining, in the sub-block buffer, a storage location used to store residual information of each decoding position is the same as a manner of determining, in the sub-block buffer, a storage location of an adjacent reference decoding position that belongs to the same sub-block as the decoding position. Therefore, for brevity, details are not described herein again.

In addition, for each sub-block, after decoding of all decoding positions in the sub-block is completed, residual information of a plurality of decoding positions arranged in one or more preset rows of the sub-block is respectively stored into a plurality of first storage locations in the row buffer, and residual information of decoding positions arranged in one or more preset columns of the sub-block is respectively stored into a plurality of second storage locations in the column buffer, where the preset rows and the preset columns are associated with a decoding mode of the transform block, each first storage location may be determined based on a second block index of a corresponding decoding position in the preset rows of the sub-block, and each second storage location is determined based on a second block index of a corresponding decoding position in the preset columns of the sub-block. In addition, in the conventional mode, after decoding of all decoding positions in each sub-block is completed, residual information of a preset diagonal decoding position of the sub-block may be further stored into a third storage location in the diagonal buffer. Herein, the preset diagonal decoding position may also be associated with the decoding mode of the transform block, and the third storage location may also be determined based on a second block index of the preset diagonal decoding position. A manner of determining, in the row buffer, the column buffer, and the diagonal buffer, storage locations used to store residual information of the decoding position in the sub-block is the same as a manner of determining, in these buffers, a storage location of an adjacent reference decoding position that belongs to a different sub-block from the decoding position. Therefore, for brevity, details are not described herein again.

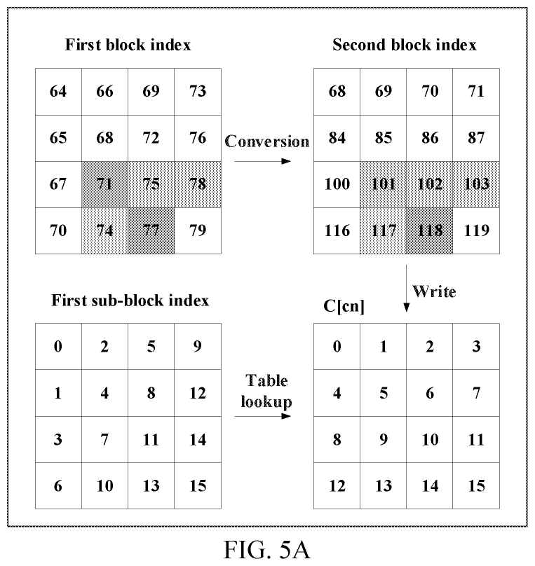

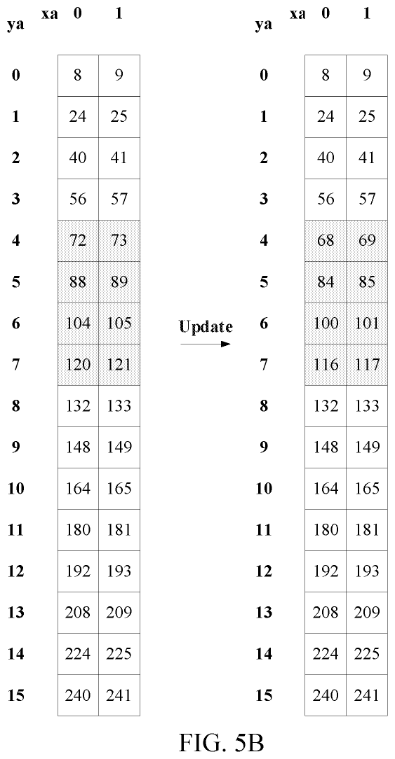

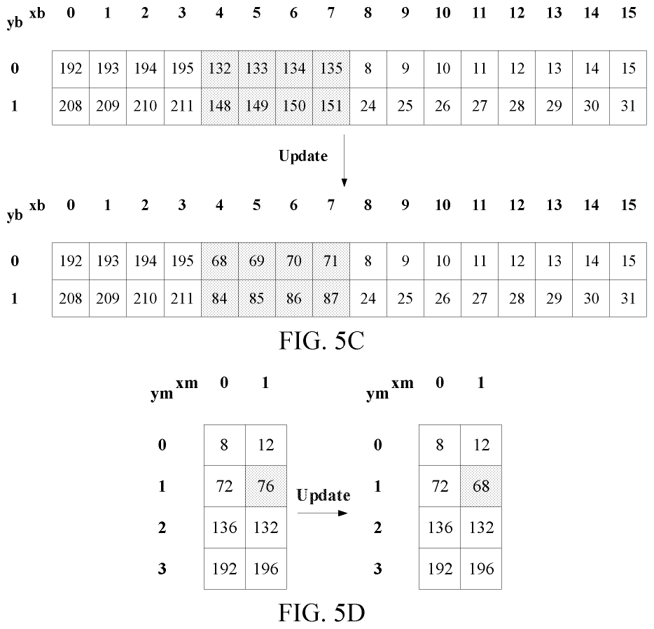

The following describes in detail, with reference to FIG. 5A to FIG. 5D, a process of updating residual information stored in each buffer according to an example embodiment of the present invention.

FIG. 5A to FIG. 5D show schematic diagrams of updating residual information stored in various buffers according to an example embodiment of the present invention. In an example embodiment of the present invention, in a feasible implementation, a corresponding sub-block buffer may be cleared before residual decoding is started for each sub-block.

Residual decoding of a sub-block 5 in the raster scanning order shown in FIG. 2A is used as an example for description. In an example embodiment of the present invention, each decoding position in the sub-block 5 is decoded in an anti-up-right diagonal sequence, that is, each decoding position in the sub-block 5 is decoded in a sequence of second block indexes 119, 103, 118, 87, 102, 117, 71, 86, 101, 116, 70, 85, 100, 69, 84, and 68. In addition, in this sequence, residual information obtained through decoding is stored into a sub-block buffer C whenever one decoding position is decoded, and is stored in a sequence of storage locations C[15], C[14], . . . , C[1], and C[0]. In other words, as shown in FIG. 5A, the sub-block buffer may be updated in the following sequence:
Residual information of R[119] is written to a position C[15] in the sub-block buffer;
residual information of R[103] is written to a position C[11] in the sub-block buffer;
residual information of R[118] is written to a position C[14] in the sub-block buffer;
residual information of R[87] is written to a position C[7] in the sub-block buffer;
residual information of R[102] is written to a position C[10] in the sub-block buffer;
residual information of R[117] is written to a position C[13] in the sub-block buffer;
residual information of R[71] is written to a position C[3] in the sub-block buffer;
residual information of R[86] is written to a position C[6] in the sub-block buffer;
residual information of R[101] is written to a position C[9] in the sub-block buffer;
residual information of R[116] is written to a position C[12] in the sub-block buffer;
residual information of R[70] is written to a position C[2] in the sub-block buffer;
residual information of R[85] is written to a position C[5] in the sub-block buffer;
residual information of R[100] is written to a position C[8] in the sub-block buffer;
residual information of R[69] is written to a position C[1] in the sub-block buffer;
residual information of R[84] is written to a position C[4] in the sub-block buffer; and
residual information of R[68] is written to a position C[0] in the sub-block buffer.

However, it should be understood that the foregoing manner of updating the sub-block buffer is merely an example, which is not limited in this application. For example, before a sub-block is decoded, a corresponding sub-block buffer may not be cleared, but in a decoding process, each time one decoding position is decoded, residual information obtained through decoding is overwritten in a corresponding storage location in a sub-block buffer, so as to replace original residual information in the storage location.

After the sub-block 5 is decoded, that is, after residual information of R[68] is decoded, the row buffer, the column buffer, and the diagonal buffer may be further updated with the residual information of the decoding positions in the sub-block 5.

In the foregoing example of the present invention, when a decoding position is decoded, one or more adjacent reference decoding positions of the decoding position are located only in two rows below, two columns on the right, and an adjacent lower right diagonal decoding position of the decoding position, residual information of two leftmost columns of decoding positions in the sub-block may be written into corresponding storage locations in the column buffer, residual information of two topmost rows of decoding positions in the sub-block may be written into corresponding storage locations in the row buffer, and residual information of an upper left corner decoding position of the sub-block may be written into a corresponding storage location in the diagonal buffer.

As an example only, as shown in FIG. 5B, a column buffer A may be updated as follows:
residual information of R[68] is written to a position A[0][4] in the column buffer;
residual information of R[84] is written to a position A[0][5] in the column buffer;
residual information of R[100] is written to a position A[0][6] in the column buffer;
residual information of R[116] is written to a position A[0][7] in the column buffer;
residual information of R[69] is written to a position A[1][4] in the column buffer;
residual information of R[85] is written to a position A[1][5] in the column buffer;
residual information of R[100] is written to a position A[1][6] in the column buffer; and
residual information of R[117] is written to a position A[1][7] in the column buffer.

That is, a gray part in FIG. 5B is an updated storage location, and residual information stored in other storage locations in the column buffer A may remain unchanged.

In addition, as shown in FIG. 5C, a row buffer B may be updated as follows:
residual information of R[68] is written to a position B[4][0] in the row buffer;
residual information of R[69] is written to a position B[5][0] in the row buffer;
residual information of R[70] is written to a position B[6][0] in the row buffer;
residual information of R[71] is written to a position B[7][0] in the row buffer;
residual information of R[84] is written to a position B[4][1] in the row buffer;
residual information of R[85] is written to a position B[5][1] in the row buffer;
residual information of R[86] is written to a position B[6][1] in the row buffer; and

residual information of R[87] is written to a position B[7][1] in the row buffer.

That is, in FIG. 5C, a gray part is an updated storage location, and residual information stored in other storage locations in the row buffer B may remain unchanged.

In addition, as shown in FIG. 5D, residual information of R[68] may be written to a position M[1][1] shown in gray in a diagonal buffer to update the diagonal buffer M, while residual information stored in other storage locations in the diagonal buffer M may remain unchanged.

The foregoing only shows a buffer setting and operation for a case in which a maximum transform block is 16×16. Such a buffer may also be applied to a smaller transform block, for example, an 8×8 transform block. In this case, only a part of a storage space of a set buffer may be used. In other words, when a plurality of sizes of transform blocks exist in a video stream, a size of each buffer to be used may be determined according to a size of a maximum transform block and a size of a maximum transform sub-block, and a buffer thus determined may be applied to other transform blocks of a smaller size.

In addition, in the foregoing description, the buffer is updated by using residual information of two columns of decoding positions on the left side and two rows of decoding positions on the top of the sub-block, but this application is not limited thereto. Decoding positions used for updating may be determined according to a positional relationship between adjacent reference decoding positions and to-be-decoded positions and a quantity thereof that are required for residual decoding. The following further describes this in detail with reference to residual decoding processing in the skip mode. In the following embodiments, the 16×16 transform block and the 4×4 sub-block are still used as examples for explanation.

FIG. 6 shows a decoding order in an anti-up-right diagonal scanning order in a skip mode and a first block index of each decoding position according to an example embodiment of the present invention. FIG. 7 shows a decoding order in a raster scanning order in a skip mode and a second block index of each decoding position.

Similar to FIG. 2A and FIG. 2B, sequences shown by dashed lines with arrows inside the transform block and the sub-block of FIG. 6 and FIG. 7 are respectively an anti-up-right diagonal scanning order and a raster scanning order. In addition, a manner of determining a first block index and a second block index of each decoding position in the transform block and a method for converting the two indexes are similar to those described with reference to FIG. 2A and FIG. 2B. Therefore, details are not described herein again.

Unlike the conventional mode described above, when residual decoding is performed on each decoding position using the anti-up-right diagonal scanning order in the skip mode, adjacent reference decoding positions used include a decoding position adjacent to an upper side of the decoding position and a decoding position adjacent to a left side of the decoding position. In this case, the foregoing diagonal buffer may not be used or may be omitted, because the decoding position adjacent to the decoding position in the diagonal direction does not need to be used as a reference as in the conventional mode.

The following describes in detail the buffers used for the skip mode according to an example embodiment of the present invention by performing residual decoding on the decoding position (hereinafter referred to as a current decoding position) with a first block index “77” in an anti-up-right diagonal scanning order.

As shown in FIG. 6, in the skip mode, reference decoding positions to be referenced by residual decoding on the current decoding position include a decoding position whose first block index is “75” and adjacent to the current decoding position and a decoding position whose first block index is “74” and adjacent to a left side of the current decoding position. Turning to the raster scanning order shown in FIG. 7, a second block index of the current decoding position is “118”, a second block index of a decoding position adjacent to an upper side of the current decoding position is “102”, and a second block index of a decoding position adjacent to a left side of the current decoding position is “117”.

When residual decoding is performed on the current decoding position, the two adjacent reference decoding positions may be determined as follows:

$$D [ 75 ] = R [ 102 ] = R [ 118 - W ] ; and$$

$$D [ 74 ] = R [ 117 ] = R [ 118 - 1 ] ;$$

where W is a width size of the transform block. Similar to the previous description in the conventional mode, first block indexes of these decoding positions may be known after the second block indexes of these decoding positions are determined.

In an example embodiment of the present invention, in the skip mode, residual information of adjacent reference decoding positions may be obtained in a plurality of buffers based on at least one of a first block index and a second block index of the adjacent reference decoding positions of the current decoding position. Herein, in the skip mode, the buffers used may include a sub-block buffer, a row buffer, and a column buffer.

In a case in which the size of the maximum transform block is 16×16 and the size of the sub-block is 4×4, for the skip mode, a quantity of storage locations of the row buffer used may be equal to 16×1, a quantity of storage locations of the column buffer may be equal to 1×16, and a quantity of storage locations of the sub-block buffer may be 4×4.

In an example embodiment of the present invention, when the current decoding position is located in the same sub-block as its adjacent reference decoding position, residual information of the adjacent reference decoding position is stored in a sub-block buffer. Therefore, a storage location of the residual information of the adjacent reference decoding position in the sub-block buffer needs to be determined, and the residual information of the adjacent reference decoding position needs to be obtained from the storage location. Herein, a manner of obtaining a storage location of residual information of an adjacent reference decoding position that is located in the same sub-block as the current decoding position is the same as a manner in the conventional mode. Therefore, for brevity, details are not described herein again.

In addition, when the current decoding position is located in a different sub-block from its adjacent reference decoding position, residual information of the adjacent reference decoding position is stored in the row buffer or the column buffer. Therefore, a storage location of the residual information of the adjacent reference decoding position in these buffers needs to be determined, and the residual information of the adjacent reference decoding position needs to be obtained from the storage location. Herein, the storage location of the residual information of the adjacent reference decoding position in the row or column buffer may be determined based on a second block index of the adjacent reference decoding position and the following manner:

$$TBx = rasterIdx \& ( TBw - 1 ) ;$$

$$TBy = rasterIdx / TBw ;$$

$$B [ xb ] , xb = TBx \& 31 ;$$

$$A [ yr ] , yr = TBy \& 31 ;$$

where TBw represents the width size of the transform block. For example, when the size of the transform block is 32×32, TBw is 32, and when the size of the transform block is 16×16, TBw is 16. TBx and TBy represent x-axis coordinates and y-axis coordinates of a decoding position when an upper left vertex of the transform block is an origin of coordinates, a height direction is a y-axis, and a width direction is an x-axis. For example, coordinates of the decoding position whose first block index is “75” may be [6, 6]. rasterldx is a second block index of a decoding position, “&” indicates a bitwise AND operation, and “/” indicates an integer division operation. B[xb] indicates a storage location in the row buffer, and A[yr] indicates a storage location in the column buffer.

In an example embodiment of the present invention, similar to the conventional mode, a buffer in which residual information of an adjacent reference decoding position is stored may be determined according to a positional relationship between the adjacent reference decoding position and the current decoding position.

Based on the manner described above, residual information respectively corresponding to adjacent reference decoding positions R[102] and R[117] may be respectively obtained from storage locations C[10] and C[13] in the sub-block buffer. In this manner, storage locations of residual information of each adjacent reference decoding position may be obtained through simple calculation based on position information of the current decoding position in the transform block. Because the storage locations of residual information of each decoding position may be determined in the foregoing manner, addressing difficulty is greatly reduced.

Similarly, in the skip mode, the storage size of the sub-block buffer may also depend on the size of the maximum sub-block, and the storage size of other buffers may depend on the size of the maximum transform block. For example, when the size of the maximum transform block is 32×32 and the size of the maximum sub-block is 4×4, the storage size of the sub-block buffer may be 4×4, the size of the row buffer may be 1×32, and the size of the column buffer may be 32×1 respectively.

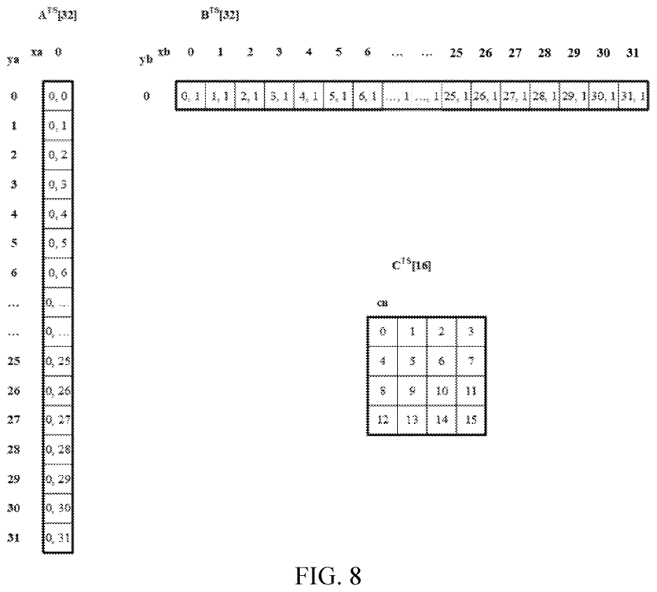

FIG. 8 shows a schematic diagram of a storage space for each buffer in a skip mode according to an example embodiment of the present invention when a maximum transform block size is 32×32.

Referring to FIG. 8, ATS represents a column buffer, and xa=0 and ya∈[0, 1, . . . 30 31] represents an index of a storage location in the column buffer. BTS indicates a row buffer, and yb=0 and xb∈[0, 1, . . . , 30, 31] indicates an index of a storage location in the row buffer. CTS represents a sub-block buffer, and cn∈[0, 1, . . . , 14, 15] represents an index of a storage location in the sub-block buffer.

As shown in FIG. 8, a storage space of all buffers includes a total of 80 storage locations. That is, in a case in which the size of the maximum transform block is 32×32 and the size of the maximum sub-block is 4×4, only a maximum of 80 storage locations are required to buffer decoded residual information during decoding of the transform block.

In addition, in an example embodiment of the present invention, in the skip mode, residual information stored in a plurality of buffers may also be updated using residual information of a plurality of decoding positions in the current sub-block obtained through decoding based on a first block index and a second block index of each decoding position in the sub-block.

Specifically, in an example embodiment of the present invention, after decoding of residual information of each decoding position is completed, a position used to store residual information of the decoding position may be determined in a corresponding sub-block buffer based on a first block index of the decoding position, and the residual information of the decoding position is stored in the determined position. Herein, a manner of determining, in the sub-block buffer, a storage location used to store residual information of each decoding position is the same as a manner of determining, in the sub-block buffer, a storage location of an adjacent reference decoding position that belongs to the same sub-block as the decoding position. Therefore, for brevity, details are not described herein again.

In addition, for each sub-block, after decoding of all decoding positions in the sub-block is completed, residual information of decoding positions in a preset row of the current sub-block is respectively stored into a plurality of first storage locations in the row buffer, and residual information of decoding positions in a preset column of the sub-block is respectively stored into a plurality of second storage locations in the column buffer, where the preset row and the preset column herein may be associated with the skip mode of the transform block, each first storage location is determined based on a second block index of a corresponding decoding position in the preset rows of the sub-block, and each second storage location is determined based on a second block index of a corresponding decoding position in the preset columns of the sub-block. In the foregoing example of the present invention, when a decoding position is decoded, reference decoding positions adjacent to the decoding position are located in only one row above and one column on the left of the decoding position. Therefore, in an example embodiment of the present invention, residual information of a rightmost column (that is, a preset column) of decoding positions in the sub-block may be written to corresponding storage locations in the column buffer, and residual information of a lowest row (that is, a preset row) of decoding positions in the sub-block may be written to corresponding storage locations in the row buffer.

Herein, a manner of determining, in the row buffer and the column buffer, storage locations used to store residual information of the decoding position in the sub-block is the same as a manner of determining, in these buffers, storage locations of an adjacent reference decoding position that belongs to a different sub-block from the decoding position. Therefore, for brevity, details are not described herein again.

Although various buffers are set for the skip mode in the foregoing embodiments, this application is not limited thereto. The buffers set for the conventional mode described above with reference to FIG. 5A to FIG. 5D may be compatible with the skip mode. For example, when the decoding mode is the conventional mode, all storage locations in these buffers may be used, and when the decoding mode is the skip mode, a part of a storage space in these buffers may be configured to store residual information. For example, a storage location with xa of 0 (or 1) in a column buffer and yb of 0 (or 1) in a row buffer for a 16×16 transform block may be set to be used for storing residual information of a reference decoding positions in the skip mode, and the sub-block buffer is used as is.

For another example, various buffers set for the 32×32 maximum transform block may alternatively be used for decoding of a transform block with another size in the skip mode. As an example only, the lower 8 bits of the row buffer with addresses B[i][0] and B[i][1] (where i=0~31) set for the 32×32 maximum transform block may be set to respectively store residual information of lower 8 bits and higher 8 bits of B^{TS}[j] (where j=0~31) of FIG. 8. Similarly, the lower 8 bits of the column buffer with addresses A[0][i] and A[1][i] (where i=0~31) set for the 32×32 maximum transform block may be set to respectively store residual information of lower 8 bits and higher 8 bits of A^{TS}j] (where j=0~31) of FIG. 8. In addition, a sub-block buffer C[i] (where i=0-15) set for the 32×32 maximum transform block may be used to store residual information that is to be stored in the lower 8 bits of C^{TS}j] (where j=0~15) of FIG. 8, a diagonal buffer M[0][i] (where i=0~7) set for the 32×32 maximum transform block is set to store residual information that is to be stored in the upper 8 bits of C^{TS}j] (where j=0~7), and M[1][i] (where i=0~7) is set to store residual information that is to be stored in the upper 8 bits of C^{TS}[j] (where j=8~15).

In other words, buffers according to example embodiments of the present invention may be compatible with various sizes of transform blocks and various decoding modes. According to the residual information storage manner described above, for the 32×32 transform block, in a case in which the conventional mode and the anti-up-right diagonal scanning order are used, residual information of a maximum of 160 decoding positions may be stored as reference context information (that is, decoded residual information) of decoding positions to be decoded, and in a case in which the skip mode and the anti-up-right diagonal scanning order are used, residual information of a maximum of 80 decoding positions may be stored as reference context information of a decoding position to be decoded. A composition of the context information and a quantity of bits of each piece of information have been described in detail in the ITU-T H.266 standard. Details are not described herein again. The following will continue to explain in detail a residual decoding operation at each decoding position with reference to the accompanying drawings.

In the following, a residual decoding operation will be explained by using a conventional mode and an anti-up-right diagonal scanning order as an example. In an example embodiment of the present invention, decoding residual information (e.g., residual values, residual coefficients, or residual coefficient levels) at a decoding position in a transform block may refer to decoding syntax elements associated with the residual information. In other words, in an example embodiment of the present invention, in a residual encoding, transmission, and residual decoding process of video data, the residual values may not be directly encoded, decoded or transmitted, but syntax elements that can be used to represent the residual value may be directly encoded and decoded and transmitted. This is because directly encoding, decoding, and transmitting the residual value requires a large quantity of bits to represent the residual value and incurs high hardware and software costs, which is inefficient for a video processing means.

In an example embodiment of the present invention, a plurality of syntax elements may be used to collectively represent one residual value. In other words, the residual values may be described from different dimensions by using different syntax elements, for example, a value of the syntax element may indicate a state of the residual value in a corresponding dimension. For example, if the residual value may have N states (where N is a positive integer) in a dimension describing the residual value, a corresponding syntax element may have N different values to respectively indicate N states. The value of a syntax element may be a flag indicating a state of the residual value. Residual information of a residual value may include a plurality of such flags.

In an example embodiment of the present invention, as an example only, residual information of each decoding position may include at least one of the following flags: a first flag used to indicate whether a corresponding residual value is zero, a second flag used to indicate parity of a corresponding residual absolute value, a third flag used to indicate whether the corresponding residual absolute value is greater than a first threshold, a fourth flag used to indicate whether the corresponding residual absolute value is greater than a second threshold, a fifth flag used to indicate a corresponding residual absolute value, a sixth flag used to indicate a corresponding residual-remainder absolute value, and a seventh flag used to indicate whether a corresponding residual value is a positive value or a negative value. Herein, in a case that the fourth flag indicates that the corresponding residual absolute value is greater than the second threshold, the sixth flag exists, and the residual-remainder absolute value indicates a difference absolute value between the corresponding residual absolute value and the second threshold.

In an example embodiment of the present invention, as described above, the sub-block may be decoded in an anti-up-right diagonal scanning order to obtain residual information of each decoding position in the sub-block. However, as may be learned from the foregoing description of the syntax elements, there is a correlation between some syntax elements, and some syntax element values may depend on one or more other syntax elements, so that decoding of these syntax elements may be implemented by using a plurality of passes of scanning.

By way of example only, an example embodiment of the present invention may implement decoding of all of the above syntax elements by three passes of scanning, which will be explained in more detail below.

In first-pass scanning, first-pass residual information (hereinafter referred to as residual information of a pass 1 part) may be decoded. Herein, the first-pass residual information may include a first flag used to indicate whether a corresponding residual value is zero, a second flag used to indicate parity of a corresponding residual absolute value, a third flag used to indicate whether the corresponding residual absolute value is greater than a first threshold, and a fourth flag used to indicate whether the corresponding residual absolute value is greater than a second threshold, where the second threshold is greater than the first threshold, as described above.

In second-pass scanning, second-pass residual information (which may be hereinafter referred to as residual information of pass 2 part) may be decoded. Herein, the second-pass residual information may include at least one of a fifth flag used to indicate a corresponding residual absolute value and a sixth flag used to indicate a corresponding residual-remainder absolute value, as described above. In the case that the fourth flag indicates that the corresponding residual absolute value is greater than the second threshold, the sixth flag may exist, and the residual-remainder absolute value may indicate a difference absolute value between the corresponding residual absolute value and the second threshold.

In third-pass scanning, third-pass residual information (which may be hereinafter referred to as residual information of pass 3 part) may be decoded. Herein, the third-pass residual information may include a seventh flag used to indicate whether a corresponding residual value is a positive value or a negative value.

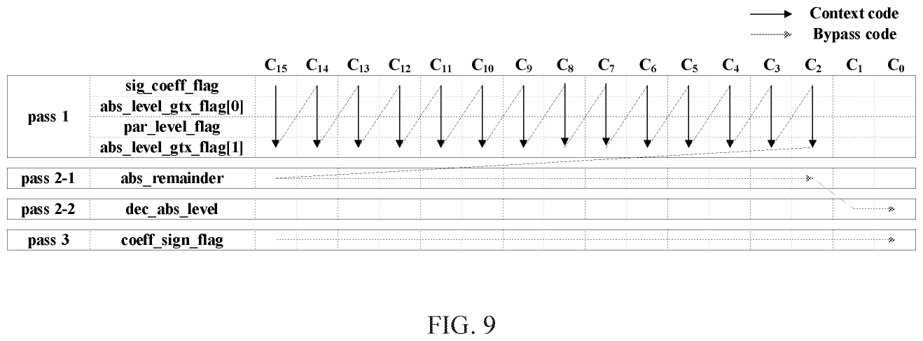

FIG. 9 shows a sequence and processing of decoding residual information according to an example embodiment of the present invention. As shown in FIG. 9, a decoding process may include decoding of a pass 1 part syntax elements (i.e., the first-pass scanning as described above), decoding of pass 2-1 and pass 2-2 part syntax elements (i.e., the second-pass scanning as described above), and decoding of a pass 3 part syntax elements (i.e., the third-pass scanning as described above). In addition, values of syntax elements sig_coeff_flag, par_level_flag, abs_level_gtx_flag[0], abs_level_gtx_flag[1], dec_abs_level, abs_remainder, and coeff_sign_flag shown in FIG. 9 respectively correspond to the first flag to the seventh flag described above, and the meanings of these syntax elements are defined in detail as follows:
sig_coeff_flag[xC][yC]: for a transform coefficient position (for example, a decoding position mentioned in this specification) (xC, yC) in a current transform block, indicates whether a corresponding transform coefficient level (for example, a residual coefficient level mentioned in the present disclosure) at the position (xC, yC) is 0, as follows: If sig_coeff_flag[xC][yC] is equal to 0, the transform coefficient level at the position (xC, yC) is 0; or if sig_coeff_flag[xC][yC] is not equal to 0 (e.g., equal to 1), the transform coefficient level at the position (xC, yC) is a non-zero value.

abs_level_gtx_flag[n][j]: used to indicate whether an absolute value of a transform coefficient level at a scanning position n in a transform block (for example, the decoding position whose block index is n in the transform block shown in FIG. 2B) is greater than (j<<1)+1. For example, abs_level_gtx_flag[n][0] corresponding to the decoding position n may indicate whether an absolute value of a residual coefficient value at the decoding position n is greater than 1. If the absolute value of the residual coefficient value is greater than 1, the syntax element value is equal to 1; otherwise, the syntax element value is 0. Similarly, abs_level_gtx_flag[n][1] corresponding to the decoding position n may indicate whether an absolute value of a residual coefficient value at the decoding position n is greater than 3. If the absolute value of the residual coefficient value is greater than 3, the syntax element value is equal to 1; otherwise, the syntax element value is 0.

par_level_flag[n]: used to indicate parity of a transform coefficient level at a scanning position n (for example, the decoding position whose block index is n in the transform block shown in FIG. 2B) in a transform block. When the transform coefficient level is an odd number, the syntax element value is 1, and when the transform coefficient level is an even number, the syntax element value is 0.

abs_remainder[n]: used to indicate a remainder absolute value of a transform coefficient level at a scanning position n in a transform block (for example, the decoding position whose block index is n in the transform block shown in FIG. 2B). For example, the transform coefficient level at the scanning position n in the transform block is relative to a remainder absolute value of a maximum value among thresholds associated with abs_level_gtx_flag[n][j]. As an example only, in the present invention, an associated comparison threshold of abs_level_gtx_flag[0] is 1, and an associated comparison threshold of abs_level_gtx_flag[1] is 3. Therefore, abs_remainder may indicate an absolute value of a transform coefficient level at a corresponding scanning position relative to a remainder of pass 1. In addition, in this case, for the scanning position n, abs_remainder exists only when abs_level_gtx_flag[1] corresponding to the scanning position n is 1 (that is, a residual coefficient value of the scanning position is greater than 3).

dec_abs_level[n]: The syntax element is an intermediate value generated by encoding/decoding by using a Golomb-Rice coding when encoding/decoding is performed at a scanning position n in a transform block, and represents an absolute value of each remaining to-be-encoded coefficients after the transform block reaches a maximum allowed bin number encoded for pass 1.

coeff_sign_flag[n]: used to indicate a sign of a transform coefficient level at a scanning position n in a transform block (for example, the decoding position whose block index is n in the transform block shown in FIG. 2B). If coeff_sign_flag[n] is equal to 0, the transform coefficient level corresponding to coeff_sign_flag[n] is a positive value; otherwise, if coeff_sign_flag[n] is equal to 1, the transform coefficient level corresponding to coeff_sign_flag[n] is a negative value, or vice versa.

Continuing to refer to FIG. 9, C15 to C0 respectively indicate decoding positions in a current sub-block that will be decoded in an anti-up-right diagonal scanning order(e.g., decoding positions whose indexes are 15, 14, . . . , 1, and 0 in FIG. 2B). In the first-pass scanning, context decoding may be performed on first-pass residual information of each decoding position in a current sub-block based on context information of the decoding position according to the first scanning order, where the context information may be determined based on first-pass residual information of one or more adjacent reference decoding positions of each decoding position. Alternatively, context decoding may not be performed on first-pass residual information of each decoding position in the current sub-block, but context decoding may be performed according to a part of decoding positions determined according to a preset demarcation point position (or a maximum allowed bin number encoded by pass 1). The demarcation point position may be determined according to the size of the transform block. For details, refer to related descriptions about the remBinsPass1 function in the T-REC-H.266 protocol. Details are not described herein again. For example, referring to FIG. 9, it is assumed that CABAC decoding may be performed on the first-pass residual information (i.e., sig_coeff_flag, abs_level_gtx_flag[0], par level flag, and abs_level_gtx_flag[1]) in the residual information of the decoding positions C15 to C2, respectively, in an order of C15 to C2.

As shown in FIG. 9, the four syntax elements sig_coeff_flag, abs_level_gtx_flag[0], par_level_flag, and abs_level_gtx_flag[1] included in the pass 1 part may all be a single context binary bit (1−context-bin). Corresponding binary bits of the four syntax elements may be combined into one syntax element pass 1 of up to 4 binary bits and encoded using Context Adaptive Binary Arithmetic Coding (CABAC). There are six cases of binary bit string (bin string) of Pass 1: 1′b0, 2′b10, 4′b 1100, 4′b 1110, 4′b 1101, and 4′b 1111, which are respectively corresponding to cases in which absLevelPass1 values are 0, 1, 2, 3, 4, and 5. Therefore, pass 1 may be indicated by a 3-bit absLevelPass1, where absLevelPass1 indicates partial reconstruction absolute values corresponding to a transform coefficient level. “1′b”, “2′b”, and “4′b” respectively represent 1 binary bit, 2 binary bits, and 4 binary bits, and one or more subsequent binary bits respectively represent values of corresponding syntax elements sig_coeff_flag, abs_level_gtx_flag[0], par_level_flag, and abs_level_gtx_flag[1]. In other words, when the value of sig_coeff_flag is 0, it indicates that a residual value of a corresponding decoding position is 0. In this case, values of the other three syntax elements may be omitted, and the value of pass 1 may be 1′b0. When the value of sig_coeff_flag is 1, it indicates that the residual value of the corresponding decoding position is not 0. In this case, if the value of abs_level_gtx_flag[0] is 0, it indicates that the residual value of the corresponding decoding position is equal to 1. In this case, values of the other two syntax elements may be omitted, and the value of pass 1 may be 2′b10. When the value of sig_coeff_flag is 1 and the value of abs_level_gtx_flag[0] is 1, it indicates that the residual value of the corresponding decoding position is greater than 1. In this case, if values of par_level_flag and abs_level_gtx_flag[1] are 0 and 0 respectively, it indicates that the residual value of the corresponding decoding position is equal to 2, and the value of pass 1 may be 4′b1 100. If the values of par_level_flag and abs_level_gtx_flag[1] are 1 and 0 respectively, it indicates that the residual value of the corresponding decoding position is equal to 3, and the value of pass 1 may be 4′b 1110. If the values of par level flag and abs_level_gtx_flag[1] are 0 and 1 respectively, it indicates that the residual value of the corresponding decoding position is greater than 3, the value of pass 1 may be 4′b 1101, and a specific residual value may be further calculated based on a value of the syntax element abs_remainder in the pass 2 part. If the values of par_level_flag and abs_level_gtx_flag[1] are 1 and 1 respectively, it indicates that the residual value of the corresponding decoding position is greater than 3, the value of pass 1 may be 4′b 1111, and a specific residual value may be further calculated based on a value of the syntax element abs_remainder in the pass 2 part. When a value of pass 1 of a decoding position is 4′b 1101 or 4′b 1111, a value of its pass 2 may be decoded. In an embodiment of the present invention, decoding of the pass 1 part may be performed until all pass 1 parts of the sub-block are decoded or a maximum allowed binary bit number preset for pass 1 is reached. For example, referring to FIG. 9, when decoding of the decoding position C2 is completed, a preset maximum allowed binary bit number is reached. In this case, decoding of the pass 1 part may be stopped, and decoding of the pass 2 part is started.

In an example embodiment of the present invention, in a process of performing context decoding on first-pass residual information of a current decoding position that is currently to be decoded, a context index value of the current decoding position may be determined based on first-pass residual information of one or more adjacent reference decoding positions of the current decoding position, and then context information is determined based on the determined context index value (for example, the corresponding context information is retrieved based on the context index value in preset or pre-stored context information). Then, context decoding may be performed on the first-pass residual information of the current decoding position based on the determined context information. A process of performing context decoding based on the context information is easy to understand by a person skilled in the art, and details are not described herein.

After decoding of the first-pass residual information, first bypass decoding may continue to be performed on second-pass residual information of each decoding position based on the first-pass residual information of the decoding position obtained through context decoding and second-pass residual information of one or more adjacent reference decoding positions of the decoding position according to the first scanning order. As an example only, as shown in FIG. 9, after decoding of the pass 1 part of the decoding position C2 has been completed, second-pass scanning may be performed again from the decoding position C15. In the second-pass scanning, the syntax element of the pass 2-1 part (i.e., abs_remainder) may be decoded first until the decoding position C2 is completed, and then decoding of the syntax element of the pass 2-2 part (i.e., dec_abs_level) is started at the decoding position C1 until the last decoding position C0.

The syntax elements abs_remainder (i.e., the pass 2-1 part) and dec_abs_level (i.e., the pass 2-2 part) included in the pass 2 part shown in FIG. 9 may be encoded using bypass coding, e.g., equiprobable CABAC coding. In bypass decoding, an inverse binarization process of the pass 2-1 and pass 2-2 parts may use mixed encoding of a truncated Rice code and a limited-k exponential Golomb code. Herein, decoding of the pass 2-1 part may be performed on only decoding positions at which decoding of the pass 1 part is completed, and decoding of the pass 2-2 part is performed on remaining decoding positions at which decoding of the pass 1 part is not performed. Alternatively, decoding of the pass 2-1 part may be performed on only decoding positions at which decoding of the pass 1 part is completed, and decoding of the pass 2-2 part is performed on all decoding positions in the current sub-block. In addition, the syntax element coeff_sign_flag included in pass 3 shown in FIG. 9 may also be encoded by bypass coding.

In an example embodiment of the present invention, in the second-pass scanning, a quantity of decoding positions to be decoded by the first bypass decoding and one or more first decoding positions corresponding to the determined number may be determined based on the first-pass residual information of each decoding position obtained through decoding; and first bypass decoding may be performed on second-pass residual information of each first decoding position based on second-pass residual information of one or more adjacent reference positions of the first decoding position.

More specifically, by way of example only, in a case in which the first bypass decoding uses equiprobable CABAC decoding and a limited-k-th order exponential Golomb (Limited-EGk) code and decodes the pass 2 part of all decoding positions of the current sub-block, in second-pass scanning, the k value cRiceParam of each first decoding position may be determined based on the second-pass residual information of the adjacent reference decoding positions of each first decoding position, and prefix codes word and suffix codes word of each first decoding position may also be decoded by using CABAC. Then, a Limited-EGk code of the second-pass residual information of each first decoding position may be determined based on the k value cRiceParam of the first decoding position and the prefix code word and the suffix code word that are obtained through decoding, and the Limited-EGk code is decoded to determine the second-pass residual information of each first decoding position.

In addition, in third-pass scanning, second bypass decoding may be performed on third-pass residual information of each decoding position in the current sub-block still according to the first scanning order. Herein, bypass decoding may be performed on syntax elements (i.e., coeff_sign_flag) of the pass 3 part in a sequence of C15 to C0. In an example embodiment of the present invention, an execution sequence of the first pass, the second pass, and the third pass is not limited to the foregoing sequence. In addition, in an example embodiment of the present invention, only second bypass decoding may be performed on third-pass residual information of non-zero decoding positions, which may be decoding positions at which a first flag in the current sub-block indicates that a corresponding residual value thereof is not zero, that is, a decoding position at which a value of a syntax element sig_coeff_flag is not 0.

In an example embodiment of the present invention, as described above, the context information of the four syntax elements sig_coeff_flag, abs_level_gtx_flag[0], par_level_flag, and abs_level_gtx_flag[1] used to decode the pass 1 part may include values of pass 1 of five adjacent reference decoding positions of the current decoding position (as shown in FIG. 2B), and each value of pass 1 may be represented by 3 bits as previously described. The k value (cRiceParam) used to decode the pass 2-1 and pass 2-2 parts may include absolute values of residual values of the five adjacent reference decoding positions of the current decoding position, and only absolute values of clipped residual values need to be stored, and each tailored value may be represented by 6 bits. In addition, the value of pass3 may not store context information.

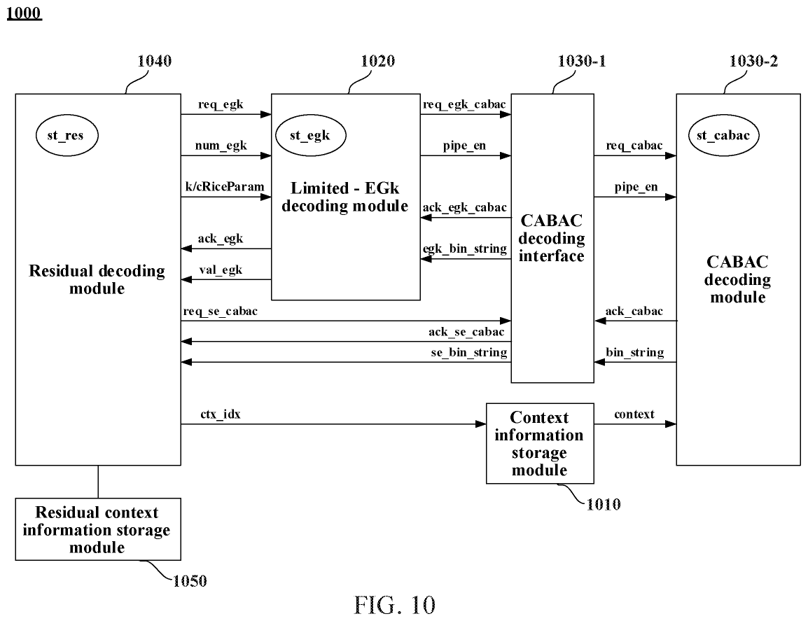

The decoding process of each pass is described in detail below with reference to FIG. 10 to FIG. 14B.

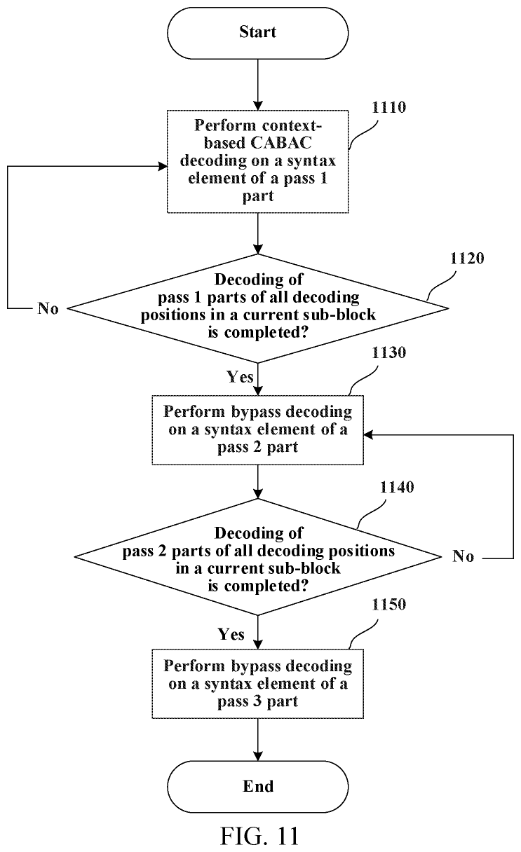

FIG. 10 shows a schematic diagram of a residual decoding means 1000 according to the present invention. FIG. 11 shows an example flowchart of performing residual decoding on a current sub-block according to an example embodiment of the present invention. The residual decoding means 1000 shown in FIG. 10 may be decoding means using context-adaptive binary arithmetic coding CABAC and a limited-k-th order exponential Golomb code Limited-EGk. Referring to FIG. 10, the residual decoding means 1000 may include a context information storage module 1010, a Limited-EGk decoding module 1020, a CABAC decoding module 1030, and a residual decoding module 1040. An example residual decoding process according to an example embodiment of the present invention will be described in detail with reference to FIG. 10 and FIG. 11. In the following example description, syntax elements of a pass 1 part, a pass 2 part, and a pass 3 part of all decoding positions of a current sub-block will be decoded.

Referring to FIG. 11, at step 1110, CABAC decoding may be performed on syntax elements of a pass 1 part of a current decoding position, such as sig_coeff_flag, abs_level_gtx_flag[0], par_level_flag, and abs_level_gtx_flag[1]. After step 1110 is completed, it may be determined at step 1120 whether decoding of context-based binary bits (context-bin) of pass 1 parts of all decoding positions in the current sub-block has been completed. In other words, it may be determined whether the current decoding position is the last decoding position in the current sub-block in an anti-up-right diagonal scanning order. If the current decoding position is not the last decoding position in the current sub-block, the process may return to step 1110 to continue to decode a syntax element of a pass 1 part of a next decoding position in the current sub-block according to the anti-up-right diagonal scanning order. On the contrary, if the current decoding position is the last decoding position in the current sub-block, it may be determined that first-pass scanning has been completed, and second-pass scanning may be entered, that is, proceeding to step 1130.

In an example embodiment of the present invention, in the first-pass scanning and decoding, referring to FIG. 10, the residual decoding module 1040 may determine a context index of first-pass residual information of each decoding position based on one or more adjacent reference decoding positions of each decoding position, and then determine residual context information for each decoding position based on the determined residual context index by using the residual context information storage module 1050. Herein, the residual context information storage module 1050 may pre-store a plurality of pieces of residual context information, and may determine corresponding residual context information based on the residual context index received from the residual decoding module 1040.

The residual decoding module 1040 determines a CABAC context index according to the residual context information for each decoding position, and then determines, based on the determined CABAC context index, CABAC context information for each CABAC binary bit by using the CABAC context information storage module 1010.

The CABAC decoding module 1030 may perform context decoding (for example, CABAC decoding) on first-pass residual information of each decoding position by using the CABAC context information for each CABAC binary bit in response to a request that is sent by the residual decoding module 1040 for decoding the first-pass residual information of each decoding position, to obtain a first-pass binary bit string of the first-pass residual information of each decoding position. Then, the residual decoding module 1040 may decode the first-pass binary bit string to obtain a value of the first-pass residual information of each decoding position, that is, a value of the pass 1 part.

Returning to FIG. 11, at step 1130, bypass decoding, such as equiprobable CABAC decoding, may be performed on syntax elements of a pass 2 part of the current decoding position, that is, abs_remainder and/or dec_abs_level. After step 1130 is completed, it may be determined at step 1140 whether decoding of bypass bins of pass 2 parts of all decoding positions in the current sub-block has been completed. In other words, it may be determined whether the current decoding position is the last decoding position in the current sub-block in an anti-up-right diagonal scanning order. If the current decoding position is not the last decoding position in the current sub-block, the process may return to step 1130 to continue to decode a syntax element of a pass 2 part of a next decoding position in the current sub-block according to the anti-up-right diagonal scanning order. On the contrary, if the current decoding position is the last decoding position in the current sub-block, it may be determined that second-pass scanning is completed, and third-pass scanning may be entered, that is, proceeding to step 1150.

With reference to the example shown in FIG. 10, in the second-pass scanning and decoding, based on the first-pass residual information of each decoding position obtained through decoding, the residual decoding module 1040 determines a quantity of decoding positions at which first bypass decoding needs to be performed, and determines first decoding positions corresponding to the determined number. Then, first bypass decoding on the second-pass residual information of the first decoding positions may be completed based on second-pass residual information of one or more adjacent reference decoding positions of the first decoding positions. For example, the residual decoding module 1040 may determine the k value cRiceParam of the first decoding positions based on the second-pass residual information of the adjacent reference decoding positions of the first decoding positions, and may send the number of the first decoding positions and the k value cRiceParam to the Limited-EGk decoding module 1020. Then, in response to a request sent by the Limited-EGk decoding module 1020 for decoding prefix code words and suffix code words of the determined number of first decoding positions, CABAC decoding may be performed on prefix code words and suffix code words of each first decoding position by using the CABAC decoding module 1030, to obtain a corresponding binary bit string of prefix code words and suffix code words of the first decoding positions. Then, based on the k value cRiceParam of the first decoding positions and the binary bit string of the prefix code word and the suffix code word obtained through decoding, a Limited-EGk code of the second-pass residual information of each first decoding position may be determined by using the Limited-EGk decoding module 1020. For example, the Limited-EGk decoding module 1020 may convert the binary bit string indicating the prefix code word and the suffix code word of each first decoding position into a corresponding prefix code word and suffix code word, and obtain the corresponding Limited-EGk code of each first decoding position by combining the converted corresponding prefix code words and suffix code words. The residual decoding module 1040 may decode the obtained Limited-EGk code to obtain a value of the second-pass residual information of each first decoding position, that is, a value of the pass 2 part.

Continuing to refer to FIG. 11, at step 1150, bypass decoding, e.g., equiprobable CABAC decoding, may be performed on a syntax element of a pass 3 part of each decoding position of the current sub-block, i.e., coeff_sign_flag.

Specifically, with reference to FIG. 10, in third-pass scanning and decoding, second bypass decoding may be performed by using the residual decoding module 1040 and the CABAC decoding module 1030, to determine whether a residual value of each decoding position is positive or negative, so as to obtain a value of the pass 3 part. As an example only, the residual decoding module 1040 may send a request to the CABAC decoding module 1030 for decoding third-pass residual information of each decoding position. The CABAC decoding module 1030 may perform CABAC decoding on the third-pass residual information to obtain a third-pass binary bit string of the third-pass residual information. Then, the residual decoding module 1040 may decode the third-pass binary bit string, to obtain the third-pass residual information for each decoding position.

Therefore, values of all residual information of the current decoding position may be obtained through three passes of scanning, so as to complete decoding of the residual information of the current decoding position.

To facilitate further detailed description of interaction and operations between the modules in the residual decoding process, the following further illustrates the residual decoding process with reference to FIG. 10 as an example. Parameters and variables used in an operation of the residual decoding means 1000 are first explained as follows:
req_egk: indicates a request for decoding a limited-k-th order exponential Golomb code (Limited-EGk code).
num_egk: indicates a quantity of consecutive decoding on the Limited-EGk code.
req_cabac: indicates a request for decoding a CABAC binary bit string (bin string).
cRiceParam: indicates a k value used to decode the Limited-EGk code.
ack_egk: indicates an ACK signal that the decoding of consecutive num_egk Limited-EGk codes has been completed.
val_egk: indicates a Limited-EGk code value obtained through decoding.
req_egk_cabac: indicates a request for decoding a CABAC binary bit string of the EGk code.
pipe_en: used to indicate whether to continuously decode a plurality of CABAC binary bit strings.
req_se_cabac: indicates a request for decoding another type of CABAC binary bit string.
ack_cabac: indicates an ACK signal that the decoding of a CABAC binary bit string has been completed.
bin_string: indicates a CABAC binary bit string.
ctx_idx_res: indicates a context index value of residual context information.
context_res: indicates residual context information.
ctx_idx_cabac: indicates a context index value of CABAC context information.
context_cabac: indicates context information used to decode a CABAC binary bit.
st_res: is a state machine used to decode residual values or residual coefficients.
st_cabac: is a state machine used to decode a CABAC binary bit string.
st_egk: is a state machine used to decode a Limited-EGk code.

In addition, as shown in FIG. 10, the CABAC decoding module 1030 may include a CABAC decoding interface 1030-1 and a CABAC decoding unit 1030-2. The CABAC decoding interface 1030-1 is configured to receive various parameter signals from another module and convert the parameter signals into a form that can be processed by the CABAC decoding unit 1030-2, and may further convert a processing result of the CABAC decoding unit 1030-2 into a form suitable for other modules and return a corresponding signal thereto.

In first-pass scanning, a context index of the first-pass residual information of each decoding position may be determined by the residual decoding module 1040 based on the adjacent reference decoding positions of the decoding position, and the residual context information storage module 1050 may determine residual context information for each decoding position based on the residual context index. The residual decoding module 1040 determines a CABAC context index according to the determined residual context information of each decoding position, and then determines, based on the determined CABAC context index, CABAC context information for each CABAC binary bit by using the CABAC context information storage module 1010. Then, in response to a request that is sent by the residual decoding module 1040 for decoding the first-pass residual information of each decoding position, the CABAC decoding module 1030 performs CABAC decoding on the first-pass residual information of each decoding position by using the CABAC context information of each CABAC binary bit to obtain the first-pass binary bit string of the first-pass residual information of each decoding position, and may decode the first-pass binary bit string of the first-pass residual information of each decoding position by using the residual decoding module 1040 to obtain the first-pass residual information of each decoding position.

Specifically, as shown in FIG. 10, the residual decoding module 1040 may send a decoding request req_se_cabac to the CABAC decoding interface 1030-1, and the decoding request req_se_cabac may be used to request to decode syntax elements sig_coeff_flag, abs_level_gtx_flag[0], par_level_flag, and abs_level_gtx_flag[1]. In addition, the residual decoding module 1040 may further determine a CABAC context index value ctx_idx_cabac of a current to-be-decoded position according to absolute values of residual values of five adjacent reference decoding positions of the current to-be-decoded position, and send the index value to the CABAC context information storage module 1010 to determine, in the CABAC context information storage module 1010, context information context_cabac of a CABAC binary bit string for a currently to-be-decoded syntax element. The determined CABAC context information context_cabac may be sent to the CABAC decoding module 1030-2 for CABAC decoding. After receiving the decoding request req_se_cabac, the CABAC decoding interface 1030-1 converts the decoding request into a request for decoding a CABAC binary bit string req_cabac and sent to the CABAC decoding module 1030-2, and sets pipe_en to 0. In an example embodiment of the present invention, a plurality of CABAC binary bits may be decoded at the same time. In this case, the residual decoding module 1040 may generate ctx_idx_cabac respectively corresponding to the plurality of CABAC binary bits, so as to obtain CABAC context information respectively corresponding to the plurality of CABAC binary bits, so as to respectively perform CABAC decoding thereon.

In an example embodiment of the present invention, the CABAC decoding unit 1030-2 may decode up to one or more context-based binary bits (context-bin) per clock cycle for four syntax elements (including sig_coeff_flag, abs_level_gtx_flag[0], par level flag, and abs_level_gtx_flag[1]) of the pass 1 part, whereby the CABAC decoding unit 1030-2 does not present an idle state in the processing of decoding sig_coeff_flag, abs_level_gtx_flag[0], par_level_flag, and abs_level_gtx_flag[1].

After decoding of the syntax elements of the pass 1 part of all the decoding positions in the current block is completed as described above, second-pass scanning may be performed. In the second-pass scanning, first a quantity of first decoding positions at which Limited-EGk decoding needs to be performed may be determined by using the residual decoding module 1040 based on the first-pass residual information of each decoding position obtained through decoding, and a k value cRiceParam of each first decoding position may be determined by using the residual decoding module based on the second-pass residual information of the adjacent reference decoding positions of the first decoding position. Then, the residual decoding module 1040 may send the determined number and the k value cRiceParam to the Limited-EGk decoding module. In response to a request sent by the Limited-EGk decoding module 1020 for decoding prefix code words and suffix code words of the number of first decoding positions, CABAC decoding may be further performed on prefix code words and suffix code words of each first decoding position by using the CABAC decoding module 1030, to obtain a second-pass binary bit string of a pair of prefix code word and suffix code word of each first decoding position. The second-pass binary bit string may be sent back to the Limited-EGk decoding module 1030, and the Limited-EGk decoding module 1020 may convert the second-pass binary bit string of each first decoding position into corresponding prefix code words and suffix code words based on the k value cRiceParam, and obtain a corresponding Limited-EGk code of each first decoding position by combining the prefix code words and the suffix code words that are obtained through conversion. The residual decoding module 1040 may decode the Limited-EGk code to obtain the second-pass residual information of each first decoding position.

Specifically, referring to FIG. 10, the residual decoding module 1040 may determine a number num_egk of Limited-EGk codes that need to be decoded, send, to the Limited-EGk decoding module 1020, a request used for decoding a Limited-EGk code of a residual value req_egk, and further provide the Limited-EGk decoding module 1020 with the number num_egk of Limited-EGk codes that need to be decoded. A total number of pass 2-1 (abs_remainder) and pass 2-2 (dec_abs_level) is num_egk. A quantity of pass 2-1 may be determined by judging whether a value is greater than 3, and abs_level_gtx_flag[1] is 1. A quantity of pass 2-2 is determined by determining whether pass 2-2 exists. When a CABAC bin number of the Pass1 part remBinsPass1 allowed by a TB block is to be used up, remaining coding positions of the current block and a residual of remaining coding blocks will be pass 2-2 dec_abs_level. For a method for determining num_egk, refer to specific descriptions of abs_remainder[n] and dec_abs_level[n] conditions in the T-REC-H.266 standard.

In addition, the residual decoding module 1040 may further determine the k value cRiceParam of the Limited-EGk code at the current to-be-decoded position according to absolute values of residual values of five adjacent reference decoding positions of the current to-be-decoded position. For example only, the k value cRiceParam of the Limited-EGk code at the current to-be-decoded position may be determined according to a sum of absolute values of the residual values of the five adjacent reference decoding positions.

After receiving the decoding request req_egk, the Limited-EGk decoding module 1020 may convert req_egk into a request for decoding a CABAC binary bit string req_egk_cabac and sent to the CABAC decoding module 1030, where the req_egk_cabac request is used to indicate that num_egk pairs of prefix code words and suffix code words need to be decoded, and each code word is one CABAC binary bit string. In this case, the Limited-EGk decoding module 1020 may set pipe_en to 1. After receiving the req_egk_cabac request, the CABAC decoding module 1030 may enter a mode of continuously decoding a plurality of CABAC binary bit strings.

Further, as shown in FIG. 10, the CABAC decoding interface 1030-1 may convert the req_egk_cabac request received from the Limited-EGk decoding module 1020 into a req_cabac request for requesting the CABAC decoding unit 1030-2 to decode the CABAC binary bit string, and further send pipe_en to the CABAC decoding unit 1030-2. After receiving the req_cabac request, the CABAC decoding unit 1030-2 may decode the CABAC binary bits, thereby implementing the decoding of the CABAC binary bit string. Each time a CABAC binary bit string is decoded, the CABAC decoding unit 1030-2 may generate an ack_cabac acknowledgment signal, and the ack_cabac signal may be returned to the Limited-EGk decoding module 1020 via the CABAC decoding interface 1030-1 together with the decoded CABAC binary bit string. In addition, when pipe_en is 1, the CABAC decoding unit 1030-2 may continue to decode a next CABAC binary bit string until pipe_en is 0 and decoding of the CABAC binary bit string is completed.

When receiving the ack_cabac signal and the decoded CABAC binary bit string, the Limited-EGk decoding module 1020 may determine whether a prefix code word or a suffix code word is currently requested, convert the received CABAC binary bit string into a corresponding prefix code word or suffix code word based on a determining result, and then combine a prefix code word and a suffix code word that correspond to the same decoding position into a Limited-EGk code. After Limited-EGk codes at all decoding positions of the current sub-block are decoded, the Limited-EGk decoding module 1020 may send an ack_egk acknowledgment signal to the residual decoding module 1040 to acknowledge that the Limited-EGk decoding operation has been completed. Herein, whether a suffix code word corresponding to a prefix code word exists may be determined based on a value of the prefix code word and a k value cRiceParam corresponding to the prefix code word. If such a suffix code word does not exist, the corresponding suffix code word may be set to 0.

In an example embodiment of the present invention, a pass 2-1 part (including a syntax element abs_remainder) and a pass 2-2 part (including a syntax element dec_abs_level) of the sub-block may be continuously decoded. As an example only, in a case in which the size of the sub-block is 4×4, there may be 16 limited-k-th order exponential Golomb codes (Limited-EGk codes). The CABAC decoding unit 1030-2 may obtain a maximum of 4 bypass bins per clock cycle by decoding, and decode to obtain all prefix code words and suffix code words of 16 limited-k-th order exponential Golomb codes (Limited-EGk codes). Corresponding prefix code words and suffix code words may be combined to form an absolute value of a residual value and returned to the residual decoding unit 1040, so that the residual decoding unit 1040 can obtain a value of the syntax element abs_remainder and/or the syntax element dec_abs_level to complete decoding of the pass 2 part.

In third-pass scanning, bypass decoding may be performed on syntax element coeff_sign_flag. Similarly, herein, the residual decoding unit 1040 may send a request (not shown) for decoding the syntax element coeff_sign_flag to the CABAC decoding interface 1030-1. After receiving the decoding request, the CABAC decoding interface 1030-1 converts the decoding request into a request (not shown) for decoding a corresponding CABAC binary bit string and sent to the CABAC decoding unit 1030-2. In response to this request, the CABAC decoding unit 1030-2 may perform bypass decoding on the syntax element coeff_sign_flag, that is, perform bypass decoding on a syntax element of a pass 3 part. In some embodiments, bypass decoding may be implemented by decoding the bypass bin using CABAC. Specifically, a plurality of bins may be decoded simultaneously per clock cycle, for example, 4 bypass bins are decoded per clock cycle. In other words, if coeff_sign_flag of the current block is 16 bins, 4 clock cycles are required to complete decoding of pass 3. Herein, as an example only, the pass 3 part of the sub-block may be a syntax element coeff_sign_flag of up to 16 binary bits obtained by combining bypass binary bits of syntax elements of the pass 3 part of each decoding position, and the CABAC decoding unit 1030-2 may obtain a complete binary bit string of the pass 3 part in a manner of decoding up to 4 bypass binary bits per clock cycle. The obtained binary bit string may be returned to the residual decoding module 1040 by using the CABAC decoding interface 1030-1, so that values of the syntax element coeff_sign_flag of each decoding position is further obtained by using the residual decoding module 1040 through decoding.

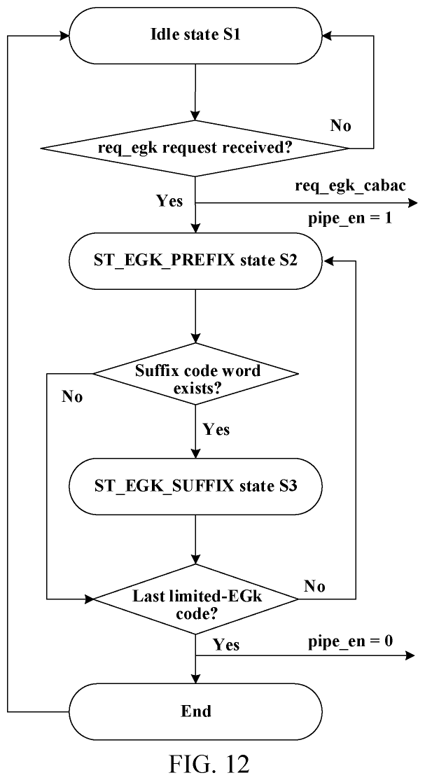

FIG. 12 shows a schematic diagram of state transition of a Limited-EGk state machine of a Limited-EGk decoding module 1020 according to an example embodiment of the present invention.

As shown in FIG. 12, the Limited-EGk state machine is initially in an idle state S1 and may determine whether a req_egk request is received in this state. If the Limited-EGk decoding module 1020 does not receive the req_egk request, the Limited-EGk state machine may remain in the idle state S1.

If the Limited-EGk decoding module 1020 receives the req_egk request, the Limited-EGk decoding module 1020 may convert the req_egk request into a request to decode num_egk pairs of prefix code words and suffix code words, where each code word is one CABAC binary bit string. In this case, the Limited-EGk state machine may enter a state S2 (i.e., state ST_EGK_PREFIX) used to decode the prefix code word. In addition, the Limited-EGk decoding module 1020 may send a request for decoding a CABAC binary bit string req_egk_cabac to the CABAC decoding module 1030, and set pipe_en to 1, thereby enabling the CABAC decoding module 1030 to enter a mode of continuously decoding a plurality of CABAC binary bit strings.

After receiving ack_cabac returned by the CABAC decoding module 1030, the Limited-EGk decoding module 1020 may determine whether a suffix code word exists. If there is a suffix code word, the Limited-EGk decoding module 1020 may enter a state S3 (i.e., state ST_EGK_SUFFIX) used to decode the suffix code word. An operation of decoding the suffix code word is similar to an operation of decoding the prefix code word. For brevity, details are not described herein again. If the suffix code word does not exist or decoding of the suffix code word has been completed, the Limited-EGk decoding module 1020 may determine whether the last Limited-EGk code is currently required for decoding. If decoding of the last Limited-EGk code is completed, the Limited-EGk decoding module 1020 may generate ack_egk to end the current decoding process, and the Limited-EGk state machine may return to the idle state S1. If the currently decoded Limited-EGk code is not the last Limited-EGk code, the Limited-EGk state machine may return to the state S2 to prepare for the decoding of a next Limited-EGk code.

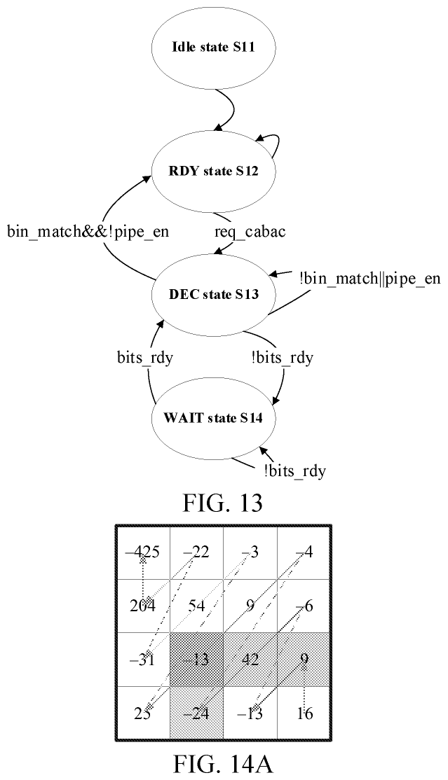

FIG. 13 shows a schematic diagram of state transition of a CABAC state machine of a CABAC decoding unit 1030-2 according to an example embodiment of the present invention.

Referring to FIG. 13, the CABAC state machine is initially in an idle state S11, and after initialization is completed, the CABAC state machine enters an RDY ready state S12. In the RDY ready state S12, when the CABAC decoding unit 1030-2 receives a decoding request for a CABAC binary bit string req_cabac, the CABAC state machine jumps to a DEC state S13. In an example embodiment of the present invention, the DEC state S13 is a decoding state of the CABAC binary bit string. In the DEC state S13, the CABAC decoding unit 1030-2 decodes the CABAC binary bit string. If decoding of a CABAC binary bit string is completed in the DEC state (bin_match becomes 1) and a CABAC continuous decoding mode is not used currently (i.e., !pipe_en or pipe_en becomes 0), the CABAC state machine enters the RDY state S12 and waits for a new decoding request for a CABAC binary bit string req_cabac. Otherwise, if the CABAC decoding unit 1030-2 has not completed decoding of a CABAC binary bit string in the DEC state (i.e., !bin_match or bin_match is 0) or the CABAC continuous decoding mode is used currently and there is an undecoded CABAC binary bit string (i.e., pipe_en=1), the CABAC state machine may remain in the DEC state S13 and continue to decode a next CABAC binary bit string. If a code stream needs to be requested for input in the DEC state S13, and the code stream is not ready (that is, !bits_rdy or bits_rdy is 0), the CABAC state machine enters a WAIT wait state S14 and waits for the code stream. In the WAIT wait state S14, if the code stream is ready (that is, !bits_rdy or bits_rdy is 1), the CABAC state machine returns to the DEC state 513, and continues to decode the CABAC binary bit string.

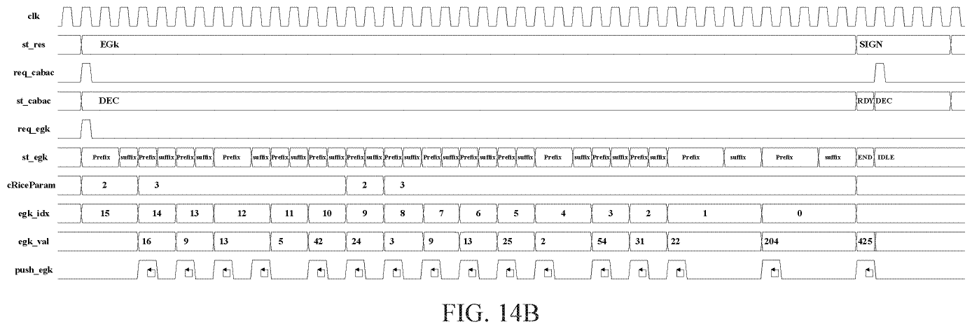

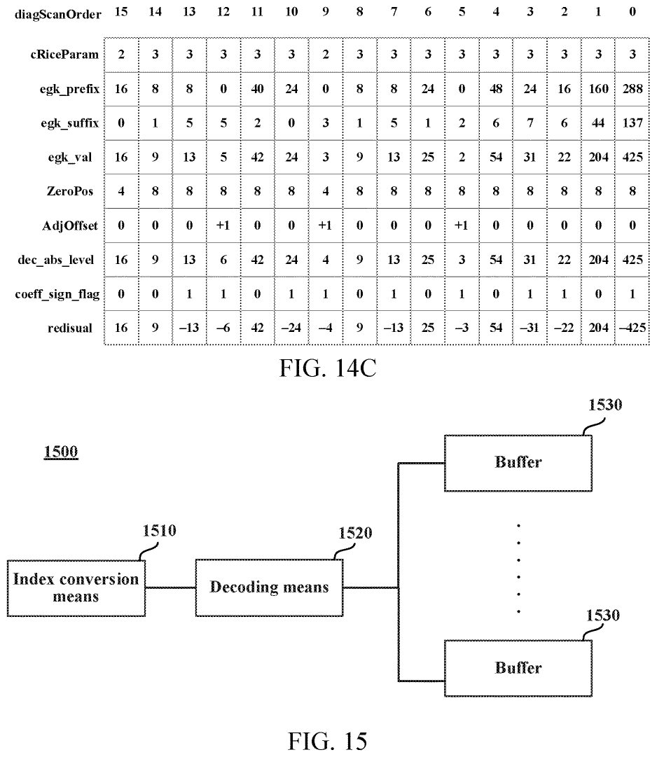

FIG. 14A shows a residual value and a decoding order at each decoding position in a to-be-decoded sub-block. FIG. 14B shows a decoding timing diagram of residual values of 16 decoding positions in the sub-block shown in FIG. 14A in an anti-up-right diagonal scanning order. FIG. 14C shows values of a related parameter during decoding at the 16 decoding positions in the sub-block shown in FIG. 14A in the sequence shown in FIG. 14A.

As an example only, in decoding process of FIG. 14B and FIG. 14C, residual values of all decoding positions in a sub-block are encoded as dec_abs_level, and meanings of parameters in FIG. 14B and FIG. 14C are as follows:
clk: indicates a clock signal.
st_res: is a state machine for decoding a residual coefficient, where a Limited-EGk state represents entering a state of decoding a limited-k-th order exponential Golomb code (Limited-EGk code), and a SIGN state represents entering a state of decoding a sign of a residual coefficient (coeff_sign_flag).
req_cabac: is a request for decoding a CABAC binary bit string.
st_cabac: is a state machine for decoding a CABAC binary bit string, where DEC is a state of decoding a binary bit, for example, the state of the prefix code word of the decoded Limited-EGk code as mentioned above. RDY is a ready state. When a decoding request for decoding a CABAC binary bit string req_cabac is received in the RDY state, the state machine will jump to the DEC state.
st_egk: is a state machine for decoding a Limited-EGk code, where Prefix is a state of decoding a prefix code word, and Suffix is a state of decoding a suffix code word.
cRiceParam: indicates decoding a k value of dec_abs_level encoded by a Limited-EGk code, and is calculated from an absolute value of a residual value of an adjacent reference decoding position of a current decoding position.
req_egk: indicates a request used to decode a Limited-EGk code.
egk_idx: indicates an index value of each Limited-EGk code when a plurality of Limited-EGk codes are decoded.
egk_val: indicates a Limited-EGk code value obtained through decoding.
push_egk: indicates that ack for each Limited-EGk code is obtained through decoding.
ZeroPos: is a variable used in a process of decoding dec_abs_level, and may be obtained as follows: ZeroPos[n]=(QState <2 ? 1:2)<<cRiceParam. For example, when QState is less than 2 and cRiceParam is 2, ZeroPos is 4. When QState is less than 2 and cRiceParam is 3, ZeroPos is 8, where QState may be equal to 0 when sh_dep_quant_used_flag is 0, otherwise QState may be obtained through table lookup. sh_dep_quant_used_flag being equal to 0 may indicate that independent quantization is used for a current slice, and being equal to 1 may indicate that non-independent quantization is used for a current slice (slice).
AdjOffset: When dec_abs_level[n] is less than ZeroPos[n], an absolute value AbsLevel[xC][yC] of a transform coefficient level is set be equal to dec_abs_level[n]+1.

The foregoing variables are known in the foregoing ITU-T H.266 standard, and therefore will not be described in more detail for brevity.

It can be clearly seen from FIG. 14B and FIG. 14C that residual information of each decoding position in the sub-block varies during the decoding process.

FIG. 15 shows a block diagram of a video decoding device 1500 according to an example embodiment of the present invention.

Referring to FIG. 15, the video decoding device 1500 according to an example embodiment of the present invention may include index conversion means 1510, decoding means 1520, and a plurality of buffers 1530.

The index conversion means 1510 may convert a first block index of at least one decoding position of the transform block in a first scanning order into a second block index in a second scanning order, and the decoding means 1520 may perform residual decoding on the plurality of sub-blocks of the transform block according to the first scanning order. The plurality of buffers 1530 may store residual information of one or more decoding positions that have been decoded.

In an example embodiment of the present invention, the decoding means 1520 may further include a residual decoding unit and a residual information updating unit. In a process of decoding each sub-block, the residual decoding unit may perform residual decoding on residual information of each decoding position in a sub-block currently decoded according to the first scanning order based on residual information that is of one or more decoding positions that have been decoded in the transform block and that is stored in a plurality of preset buffers. The residual information updating unit may update, based on the first block index and the second block index of the decoding position in the current sub-block, residual information of decoded decoding positions stored in the plurality of buffers 1530 by using decoded residual information of at least a part of decoding positions in the current sub-block.

The foregoing describes in detail a specific manner of an operation performed by each apparatus and unit in FIG. 15 with reference to FIG. 1 to FIG. 14C. Details are not described herein again.

It should be noted that although several steps of a method for decoding a video, and several modules or submodules of a means for decoding a video are mentioned in the foregoing detailed description, such division is merely an example and not mandatory. In fact, according to embodiments of this application, the features and functions of the two or more modules described above may be embodied in one module. On the contrary, features and functions of one module described above may be further divided into a plurality of modules to be embodied.

The foregoing describes a video decoding device and method according to an example embodiment of this application with reference to FIG. 1 to FIG. 15. However, the systems, apparatuses, units, or modules shown in the accompanying drawings may be respectively configured as software, hardware, firmware, or any combination of the foregoing to perform a specific function. For example, these systems, apparatuses, units, or modules may correspond to a dedicated integrated circuit, or may correspond to pure software code, or may correspond to a module in which software and hardware are combined. In addition, one or more functions implemented by these systems, apparatuses, units, or modules may also be performed collectively by a component in a physical entity device (e.g., a processor, a client, or a server).

In addition, the foregoing method may be implemented by a computer program product, such as a computer program recorded on a computer readable storage medium. For example, according to an example embodiment of this application, a computer readable storage medium storing computer program code may be provided, where when instructions are executed by at least one computing apparatus, the at least one computing apparatus is caused to perform the following steps: converting a first block index of at least one decoding position of a transform block in a first scanning order into a second block index in a second scanning order, where the second scanning order is different from the first scanning order; and performing residual decoding on the plurality of sub-blocks of the transform block according to the first scanning order; where a step of performing residual decoding on each sub-block includes: performing residual decoding on residual information of each decoding position in a sub-block currently decoded according to the first scanning order based on residual information that is of one or more decoding positions that have been decoded in the transform block and that is stored in a plurality of preset buffers; and updating the residual information of the decoding positions stored in the plurality of buffers according to residual information of at least a part of decoded decoding positions.

In addition, according to another example embodiment of this application, a computer readable storage medium storing computer program code may be provided, where when the code is run by at least one computing apparatus, the at least one computing apparatus is caused to perform the following steps: converting a first block index of at least one decoding position of a transform block in a first scanning order into a second block index in a second scanning order, where the second scanning order is different from the first scanning order; and performing residual decoding on the plurality of sub-blocks of the transform block according to the first scanning order; where a step of performing residual decoding on each sub-block includes: performing residual decoding on residual information of each decoding position in a sub-block currently decoded according to the first scanning order based on residual information that is of one or more decoding positions that have been decoded in the transform block and that is stored in a plurality of preset buffers; and updating the residual information of the decoding positions stored in the plurality of buffers according to residual information of at least a part of decoded decoding positions.

The computer program code stored in the foregoing computer readable storage medium may run in an environment deployed in a computer device such as a client, a host, a proxy device, and a server. It should be noted that the computer program code may further perform more specific processing when performing the foregoing steps. The content of the further processing is already mentioned in the descriptions in FIG. 1 to FIG. 15. Therefore, to avoid repetition, details are not described herein again.

It should be noted that the video decoding device and method according to example embodiments of this application may be implemented entirely through the execution of a computer program or instructions to implement a corresponding function, that is, each means corresponds to each step in a functional architecture of the computer program, so that the entire system is invoked by a dedicated software package (e.g., lib library) to implement a corresponding function.

In addition, when each system, apparatus, unit, or module shown in the accompanying drawings is implemented in software, firmware, middleware, or microcode, program code or code segment used to perform corresponding operations may be stored in a computer readable medium such as a storage medium, so that at least one processor or at least one computing apparatus may perform a corresponding operation by reading and running corresponding program code or code segment.

For example, according to an example embodiment of this application, a video decoding means including at least one processor and at least one memory storing computer program code may be provided. When the computer program code is run by the at least one processor, the at least one processor is caused to perform the following steps: converting a first block index of at least one decoding position of a transform block in a first scanning order into a second block index in a second scanning order, where the second scanning order is different from the first scanning order; and performing residual decoding on the plurality of sub-blocks of the transform block according to the first scanning order; where a step of performing residual decoding on each sub-block includes: performing residual decoding on residual information of each decoding position in a sub-block currently decoded according to the first scanning order based on residual information that is of one or more decoding positions that have been decoded in the transform block and that is stored in a plurality of preset buffers; and updating the residual information of the decoding positions stored in the plurality of buffers according to residual information of at least a part of decoded decoding positions.

A person of ordinary skill in the art may understand and implement other changes to the disclosed embodiments by studying the specification, the disclosed content, the accompanying drawings, and the appended claims. In the claims, the words “comprise” do not rule out other elements and steps, and the words “a” and “one” do not rule out plural. In an actual application of this application, one part may perform functions of a plurality of technical features referenced in the claims. Any reference numeral in the claims shall not be construed as limiting the scope.

Although aspects and embodiments of this application are disclosed herein, other aspects and embodiments are also clear to a person skilled in the art. A person skilled in the art may modify, equivalently replace, and combine the technical features of the video processing device on the basis of the aspects and embodiments of this application, without departing from the spirit and scope of this application. The aspects and embodiments disclosed herein are intended only for illustrative purposes and not for limiting purposes. The protection scope and spirit of this application are determined by the appended claims.

1. A video decoding method, used for decoding a transform block of a video image, wherein the transform block is divided into a plurality of sub-blocks, and each sub-block comprises a plurality of decoding positions arranged in rows and columns, and the method comprises:
converting a first block index of at least one decoding position of the transform block in a first scanning order into a second block index in a second scanning order, wherein the second scanning order is different from the first scanning order; and
performing residual decoding on the plurality of sub-blocks of the transform block according to the first scanning order;
wherein a step of performing residual decoding on each sub-block comprises:
performing residual decoding on residual information of each decoding position in a sub-block currently decoded according to the first scanning order based on residual information that is of one or more decoding positions that have been decoded in the transform block and that is stored in a plurality of preset buffers; and
updating the residual information of the decoding positions stored in the plurality of buffers according to residual information of at least a part of decoded decoding positions.

2. The method according to claim 1, wherein the step of updating the residual information of the decoding positions stored in the plurality of buffers according to residual information of at least a part of decoded decoding positions comprises:
determining a corresponding storage location to be updated in the plurality of buffers based on at least one of a first block index and a second block index of each decoding position of the at least a part of decoding positions; and
storing residual information of each decoding position of the at least a part of decoding positions into the corresponding storage location.

3. The method according to claim 2, wherein the plurality of buffers comprise:
a row buffer, configured to store residual information of a plurality of row reference decoding positions, wherein the plurality of row reference decoding positions are a plurality of decoding positions arranged in a row direction in a decoded sub-block for reference by residual decoding on an undecoded sub-block;
a column buffer, configured to store residual information of a plurality of column reference decoding positions, wherein the plurality of column reference decoding positions are a plurality of decoding positions arranged in a column direction in a decoded sub-block for reference by residual decoding on an undecoded sub-block; and
a sub-block buffer, configured to store residual information of a decoding position that is in a current sub-block and that has been decoded; and
the step of updating the residual information of the decoding positions stored in the plurality of buffers according to residual information of at least a part of decoded decoding positions comprises:
for each decoding position, after decoding of residual information of the decoding position is completed, determining, in a corresponding sub-block buffer based on a first block index of the decoding position, a storage location used to store the residual information of the decoding position, and storing, into the determined storage location, the residual information obtained through decoding; and
for each sub-block, after decoding of all decoding positions in the sub-block is completed, respectively storing residual information of a plurality of decoding positions arranged in one or more preset rows of the sub-block into a plurality of first storage locations in the row buffer, and respectively storing residual information of decoding positions arranged in one or more preset columns of the sub-block into a plurality of second storage locations in the column buffer, wherein the preset rows and the preset columns are associated with a decoding mode of the transform block, each first storage location is determined based on a second block index of a corresponding decoding position in the preset rows of the sub-block, and each second storage location is determined based on a second block index of a corresponding decoding position in the preset columns of the sub-block.

4. The method according to claim 3, wherein the step of updating the residual information of the decoding positions stored in the plurality of buffers according to residual information of at least a part of decoded decoding positions further comprises:
emptying the sub-block buffer before residual decoding starts on a current sub-block.

5. The method according to claim 3, wherein the plurality of buffers further comprise:
a diagonal buffer, configured to store residual information of a plurality of diagonal reference decoding positions, wherein the plurality of diagonal reference decoding positions are a plurality of decoding positions arranged in a diagonal direction in a decoded sub-block for reference by residual decoding on an undecoded sub-block,
wherein the step of updating the residual information of the decoding positions stored in the plurality of buffers according to residual information of at least a part of decoded decoding positions further comprises:
after decoding of all decoding positions of the current sub-block is completed, storing residual information of a preset diagonal decoding position of the current sub-block into a third storage location in the diagonal buffer, wherein the preset diagonal decoding position is associated with the decoding mode of the transform block, and the third storage location is determined based on a second block index of the preset diagonal decoding position.

6. The method according to claim 5, wherein the step of performing residual decoding on residual information of each decoding position in a sub-block currently decoded according to the first scanning order based on residual information that is of one or more decoding positions that have been decoded in the transform block and that is stored in a plurality of preset buffers comprises:
determining, based on a second block index of a current decoding position, a first block index and a second block index of an adjacent reference decoding position that is adjacent to the current decoding position and that is referenced by residual decoding on the current decoding position;
determining a storage location of residual information of the adjacent reference decoding position in the plurality of buffers based on at least one of the first block index and the second block index of the adjacent reference decoding position, and obtaining the residual information of the adjacent reference decoding position from the determined storage location; and
performing residual decoding on residual information of the current decoding position based on the obtained residual information of the adjacent reference decoding position.

7. The method according to claim 6, wherein in a case that the decoding mode of the transform block is a conventional residual decoding mode and the first scanning order is an anti-up-right diagonal scanning order, the adjacent reference decoding position comprises the following decoding positions of one or more decoding positions that have been decoded in the current sub-block, the row reference decoding position, the column reference decoding position, and the diagonal reference decoding position:
a first reference decoding position adjacent to a right side of the current decoding position;
a second reference decoding position adjacent to a right side of the first reference decoding position;
a third reference decoding position adjacent to a lower side of the current decoding position;
a fourth reference decoding position adjacent to a lower side of the third reference decoding position; and
a fifth reference decoding position adjacent to a lower right corner of the current decoding position,
wherein the one or more preset rows are two topmost rows of the current sub-block, the one or more preset columns are two leftmost columns of the current sub-block, and the preset diagonal decoding position is an top-left corner decoding position of the current sub-block.

8. The method according to claim 6, wherein in a case that the decoding mode of the transform block is a transform skip mode and the first scanning order is an up-right diagonal scanning order, the adjacent reference decoding position comprises the following decoding positions of one or more decoding positions that have been decoded in the current sub-block, the row reference decoding position, and the column reference decoding position:
a sixth reference decoding position adjacent to an upper side of the current decoding position and a seventh reference decoding position adjacent to a left side of the current decoding position,
wherein the one or more preset rows are a lowest row of the current sub-block, and the one or more preset columns are a rightmost column of the current sub-block.

9. The method according to claim 7, wherein
a quantity of storage locations in the sub-block buffer is equal to a quantity of decoding positions comprised in a maximum sub-block of the plurality of sub-blocks;
a quantity of storage locations in the row buffer is equal to M×2, wherein M is a column size of a maximum transform block of the video image;
a quantity of storage locations in the column buffer is equal to 2×N, wherein N is a row size of the maximum transform block of the video image; and
a quantity of storage locations in the diagonal buffer is twice a quantity of sub-blocks that are in the maximum transform block of the video image and that are in a longest up-right diagonal direction.

10. The method according to claim 8, wherein
a quantity of storage locations in the sub-block buffer is equal to a quantity of decoding positions comprised in a maximum sub-block of the plurality of sub-blocks;
a quantity of storage locations in the row buffer is equal to M, wherein M is a column size of a maximum transform block of the video image; and
a quantity of storage locations in the column buffer is equal to N, wherein N is a row size of the maximum transform block of the video image.

11. The method according to claim 1, wherein the residual information of each decoding position comprises at least one of the following residual information:
first-pass residual information, comprising a first flag used to indicate whether a corresponding residual value is zero, a second flag used to indicate parity of a corresponding residual absolute value, a third flag used to indicate whether the corresponding residual absolute value is greater than a first threshold, and a fourth flag used to indicate whether the corresponding residual absolute value is greater than a second threshold, wherein the second threshold is greater than the first threshold;
second-pass residual information, comprising at least one of a fifth flag used to indicate a corresponding residual absolute value and a sixth flag used to indicate a corresponding residual-remainder absolute value; and
third-pass residual information, comprising a seventh flag used to indicate whether a corresponding residual value is a positive value or a negative value, wherein in a case that the fourth flag indicates that the corresponding residual absolute value is greater than the second threshold, the sixth flag exists, and the residual-remainder absolute value indicates a difference absolute value between the corresponding residual absolute value and the second threshold.

12. The method according to claim 11, wherein the step of performing residual decoding on residual information of each decoding position in a sub-block currently decoded according to the first scanning order based on residual information that is of one or more decoding positions that have been decoded in the transform block and that is stored in a plurality of preset buffers comprises:
performing context decoding on first-pass residual information of each decoding position in a current sub-block based on context information of the decoding position according to the first scanning order, wherein the context information is determined based on first-pass residual information of one or more adjacent reference decoding positions of each decoding position;
performing, according to the first scanning order, first bypass decoding on second-pass residual information of each decoding position based on the first-pass residual information of the decoding position obtained through decoding and second-pass residual information of the adjacent reference decoding positions of the decoding position; and
performing second bypass decoding on third-pass residual information of each decoding position according to the first scanning order.

13. The method according to claim 12, wherein the step of performing second bypass decoding on third-pass residual information of each decoding position comprises:
performing second bypass decoding on third-pass residual information of a non-zero decoding position in the current sub-block, wherein the non-zero decoding position is a decoding position whose corresponding residual value is not zero as indicated by a first flag in the current sub-block.

14. The method according to claim 12, wherein the step of performing context decoding on first-pass residual information of each decoding position in a current sub-block based on context information of the decoding position comprises:
determining a context index value of a current decoding position based on first-pass residual information of one or more adjacent reference decoding positions of the current decoding position;
determining the context information based on the determined context index value; and
performing context decoding on first-pass residual information of the current decoding position based on the context information.

15. The method according to claim 12, wherein the step of performing first bypass decoding on second-pass residual information of each decoding position based on the first-pass residual information of the decoding position obtained through decoding and second-pass residual information of the adjacent reference decoding positions of the decoding position comprises:
determining, based on the first-pass residual information of each decoding position obtained through decoding, a quantity of decoding positions to be decoded by the first bypass decoding, and determining one or more first decoding positions corresponding to the determined number; and
performing first bypass decoding on second-pass residual information of the first decoding position based on second-pass residual information of one or more adjacent reference decoding positions of the first decoding position.

16. The method according to claim 15, wherein the step of performing first bypass decoding on second-pass residual information of the first decoding position based on second-pass residual information of one or more adjacent reference decoding positions of the first decoding position comprises:
determining a k value cRiceParam of the first decoding position based on the second-pass residual information of the adjacent reference decoding positions of the first decoding position;
performing context-adaptive binary arithmetic coding CABAC decoding on a prefix code word and a suffix code word of the first decoding position;
determining a Limited-EGk code of second-pass residual information of the first decoding position based on the k value cRiceParam of the first decoding position, the prefix code word and the suffix code word obtained through decoding; and
decoding the Limited-EGk code to determine the second-pass residual information of the first decoding position.

17. The method according to claim 12, wherein the context decoding is CABAC decoding, and the first bypass decoding and the second bypass decoding are equiprobable CABAC decoding.

18. A video decoding device, used for decoding a transform block of a video image, wherein the transform block is divided into a plurality of sub-blocks, and each sub-block comprises a plurality of decoding positions arranged in rows and columns, and the device comprises:
index conversion means, configured to convert a first block index of at least one decoding position of the transform block in a first scanning order into a second block index in a second scanning order, wherein the second scanning order is different from the first scanning order;
decoding means, configured to perform residual decoding on the plurality of sub-blocks of the transform block according to the first scanning order; and
a plurality of buffers, configured to store residual information of one or more decoding positions that have been decoded,
wherein the decoding means comprises:
a residual decoding unit, configured to perform residual decoding on residual information of each decoding position in a sub-block currently decoded according to the first scanning order based on residual information that is of one or more decoding positions that have been decoded in the transform block and that is stored in a plurality of preset buffers; and
a residual information updating unit, configured to update the residual information of the decoding positions stored in the plurality of buffers according to residual information of at least a part of decoded decoding positions.

19. The device according to claim 18, wherein the residual information of each decoding position comprises at least one of the following residual information:
first-pass residual information, comprising a first flag used to indicate whether a corresponding residual value is zero, a second flag used to indicate parity of a corresponding residual absolute value, a third flag used to indicate whether the corresponding residual absolute value is greater than a first threshold, and a fourth flag used to indicate whether the corresponding residual absolute value is greater than a second threshold, wherein the second threshold is greater than the first threshold;
second-pass residual information, comprising at least one of a fifth flag used to indicate a corresponding residual absolute value and a sixth flag used to indicate a corresponding residual-remainder absolute value; and
third-pass residual information, comprising a seventh flag used to indicate whether a corresponding residual value is a positive value or a negative value,
wherein in a case that the fourth flag indicates that the corresponding residual absolute value is greater than the second threshold, the sixth flag exists, and the residual-remainder absolute value indicates a difference absolute value between the corresponding residual absolute value and the second threshold.

20. The device according to claim 19, wherein the residual decoding unit is configured to:
perform context decoding on first-pass residual information of each decoding position in a current sub-block based on context information of the decoding position according to the first scanning order, wherein the context information is determined based on first-pass residual information of one or more adjacent reference decoding positions of each decoding position;
perform, according to the first scanning order, first bypass decoding on second-pass residual information of each decoding position based on the first-pass residual information of the decoding position obtained through decoding and second-pass residual information of the adjacent reference decoding positions of the decoding position; and
perform second bypass decoding on third-pass residual information of each decoding position according to the first scanning order.

21. The device according to claim 20, wherein the residual decoding unit comprises: a context information storage module, a Limited-EGk decoding module, a CABAC decoding module, and a residual decoding module,
wherein the operation of performing context decoding on the first-pass residual information of each decoding position comprises:
determining a context index of first-pass residual information of each decoding position by using the residual decoding module based on one or more adjacent reference decoding positions of the decoding position;
determining, based on the context index, context information for each decoding position by using the context information storage module;
in response to a request sent by the residual decoding module for decoding the first-pass residual information of each decoding position, performing CABAC decoding on the first-pass residual information of the decoding position by using the CABAC decoding module by using the context information of the decoding position, to obtain a first-pass binary bit string of the first-pass residual information of the decoding position; and
decoding the first-pass binary bit string by using the residual decoding module, to obtain the first-pass residual information of each decoding position;
wherein the operation of performing first bypass decoding on second-pass residual information of each decoding position based on the first-pass residual information of the decoding position obtained through decoding and second-pass residual information of the adjacent reference decoding positions of the decoding position comprises:
determining, by using the residual decoding module based on the first-pass residual information of each decoding position obtained through decoding, a quantity of first decoding positions at which Limited-EGk decoding needs to be performed, and determining, by using the residual decoding module, a k value cRiceParam of each first decoding position based on the second-pass residual information of the adjacent reference decoding positions of the first decoding position;
sending, by using the residual decoding module, the number and the k value cRiceParam to the Limited-EGk decoding module;
in response to a request sent by the Limited-EGk decoding module for decoding prefix code words and suffix code words of the number of first decoding positions, performing CABAC decoding on a prefix code word and a suffix code word of each first decoding position by using the CABAC decoding module, to obtain a second-pass binary bit string of a pair of prefix code word and suffix code word of each first decoding position;
converting the second-pass binary bit string of each first decoding position into a corresponding prefix code word and suffix code word by using the Limited-EGk decoding module based on the k value cRiceParam, and obtaining a corresponding Limited-EGk code of each first decoding position by combining the prefix code word and the suffix code word that are obtained through conversion; and
decoding the Limited-EGk code by using the residual decoding module, to obtain the second-pass residual information of each first decoding position,
wherein the step of performing second bypass decoding on the third-pass residual information of each decoding position comprises:
in response to a request sent by the residual decoding module for decoding the third-pass residual information of each decoding position, performing CABAC decoding on the third-pass residual information of each decoding position by using the CABAC decoding module, to obtain a third-pass binary bit string of third-pass residual information of all decoding positions of the current sub-block; and
decoding the third-pass binary bit string by using the residual decoding module, to obtain the third-pass residual information of each decoding position.
